(19) United States
(12) Patent Application Publication
(10) Pub. No.: US 2020/0132007 A1
(43) Pub. Date: Apr. 30, 2020

(54) CONTROLLER FOR INTERNAL COMBUSTION ENGINE

(71) Applicant: TOYOTA JIDOSHA KABUSHIKI KAISHA, Toyota-shi (JP)

(72) Inventor: Takeshi GENKO, Toyota-shi (JP)

(73) Assignee: TOYOTA JIDOSHA KABUSHIKI KAISHA, Toyota-shi (JP)

(21) Appl. No.: 16/659,658

(22) Filed: Oct. 22, 2019

(30) Foreign Application Priority Data
Oct. 26, 2018 (JP) 2018-201922
Oct. 26, 2018 (JP) 2018-201923
Oct. 26, 2018 (JP) 2018-201924
Oct. 26, 2018 (JP) 2018-201925

(51) Int. Cl. F02D 41/14; F02D 41/34

(52) U.S. Cl. CPC F02D 41/1475; F02D 41/0295; F02D 41/34

(57) ABSTRACT

A controller for an internal combustion engine includes processing circuitry. The processing circuitry is configured to execute an inflow process when an oxygen storage amount of the catalyst is greater than or equal to a predetermined amount. The inflow process includes operating the fuel injection valve to cause a fluid containing oxygen and unburned fuel to flow into the catalyst. An amount of the unburned fuel is greater than or equal to an ideal amount of unburned fuel that reacts with all of the oxygen. The processing circuitry is configured to execute, based on a detection value of the air-fuel ratio sensor obtained during an execution of the inflow process, a deviation amount calculation process that calculates a deviation amount indication value that indicates a deviation amount of a detection value of the air-fuel ratio sensor.

### BACKGROUND

### 1. Field

The present disclosure relates to a controller for an internal combustion engine.

### 2. Description of Related Art

An example of an internal combustion engine includes a catalyst capable of storing oxygen and an upstream air-fuel ratio sensor provided upstream of the catalyst in the exhaust passage. A known air-fuel ratio feedback control controls a detection value of the upstream air-fuel ratio sensor to a target value. The specification of Japanese Patent No. 5949957 describes a downstream air-fuel ratio sensor provided downstream of the catalyst. The publication describes a controller that sets the target value to be richer than the stoichiometric air-fuel ratio when the detection value of the downstream air-fuel ratio sensor is leaner than the stoichiometric air-fuel ratio, and sets the target value to be leaner than the stoichiometric air-fuel ratio when the detection value of the downstream air-fuel ratio sensor is richer than the stoichiometric air-fuel ratio (FIG. 11).

The detection value of the downstream air-fuel ratio sensor may deviate from a detection value that corresponds to the actual air-fuel ratio due to, for example, the differences between downstream air-fuel ratio sensors, age deterioration, and temperature characteristics. For example, if the above-described device controls the changing of the target value using a deviated detection value, the oxygen storage amount in the catalyst may not be able to be maintained at an appropriate value. This may lower the exhaust removal performance of the catalyst. Therefore, deviation of detection values needs to be coped with.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Hereinafter, embodiments of the present disclosure and their operation and advantages will be described.

Aspect 1. An aspect of the present disclosure provides a controller for an internal combustion engine that includes a fuel injection valve, a catalyst provided in an exhaust passage and capable of storing oxygen, and an air-fuel ratio sensor provided downstream of the catalyst in the exhaust passage. The controller includes processing circuitry. The processing circuitry is configured to execute an inflow process when an oxygen storage amount of the catalyst is greater than or equal to a predetermined amount. The inflow process includes operating the fuel injection valve to cause a fluid containing oxygen and unburned fuel to flow into the catalyst. An amount of the unburned fuel is greater than or equal to an ideal amount of unburned fuel that reacts with all of the oxygen. The processing circuitry is configured to execute, based on a detection value of the air-fuel ratio sensor obtained during an execution of the inflow process, a deviation amount calculation process that calculates a deviation amount indication value that indicates a deviation amount of a detection value of the air-fuel ratio sensor.

When the oxygen storage amount of the catalyst is greater than or equal to a predetermined amount, fluid containing oxygen and unburned fuel flows into the catalyst. In this case, even when the fluid contains an amount of unburned fuel that is greater than the ideal amount of unburned fuel reacting with all of the oxygen contained in the fluid, the excess unburned fuel reacts with oxygen stored in the catalyst. Thus, the unburned fuel flowing downstream of the catalyst is negligible. Further, since the amount of oxygen in the fluid is less than or equal to the ideal amount of oxygen that reacts with all of the unburned fuel in the fluid, the amount of oxygen flowing downstream of the catalyst is also negligible. Therefore, as described above, in a case in which the inflow process is started when the oxygen storage amount is greater than or equal to the predetermined amount, the amount of oxygen and the amount of unburned fuel in the fluid flowing out downstream of the catalyst are negligible. Therefore, the fluid to which the air-fuel ratio sensor is exposed during execution of the inflow process in the above configuration is equivalent to the fluid to which the air-fuel ratio sensor is exposed when the air-fuel ratio of the mixture to be burned is the stoichiometric air-fuel ratio. Thus, the deviation amount indication value may be calculated based on the deviation amount from the detection value assumed when the air-fuel ratio of the mixture to be burned is the stoichiometric air-fuel ratio. With the above configuration, the deviation of the detection value of the air-fuel ratio sensor is recognized, and hence the deviation may be resolved.

Aspect 2. In the controller according to aspect 1, the deviation amount calculation process may include using, as an input, the detection value obtained when an absolute value of an amount of change in a flow rate of the fluid in a predetermined period is less than or equal to a predetermined amount.

When the absolute value of the amount of change in the flow rate of the fluid is high, as compared to when it is small, the detection value of the air-fuel ratio sensor is likely to fluctuate. Thus, in the above configuration, a detection value obtained when the absolute value of the amount of change in the flow rate of the fluid is less than or equal to a predetermined amount is used as the input of the deviation amount calculation process. Hence, as compared to a configuration in which the detection value is acquired when the absolute value of the amount of change in the flow rate of the fluid is greater than the predetermined amount, the deviation amount indication value may be calculated based on a detection value obtained when the detection value of the air-fuel ratio sensor is stable. Thus, the deviation amount indication value is calculated with high accuracy.

Aspect 3. In the controller according to aspect 1, the deviation amount calculation process may include using, as an input, the detection value obtained when an absolute value of an amount of change in the detection value in a predetermined period is less than or equal to a specified amount.

A state in which the absolute value of the amount of change in the detection value is less than or equal to the specified amount suggests that the amount of oxygen and the amount of unburned fuel in the fluid flowing downstream of the catalyst are negligible. That is, the absolute value of the amount of change in the detection value is negligible. In the above configuration, a detection value obtained when the absolute value of the amount of change in the detection value is less than or equal to the specified amount is used as the input of the deviation amount calculation process. Thus, the deviation amount calculation process is executed based on the detection value obtained when it is determined that the amount of oxygen and the amount of unburned fuel in the fluid to which the air-fuel ratio sensor is exposed are negligible based on the detection value of the air-fuel ratio sensor.

Aspect 4. In the controller according to any one of aspects 1 to 3, the deviation amount calculation process may include using, as an input, the detection value obtained when the detection value satisfies a predetermined condition. The processing circuitry may be configured to execute a condition variable process that mitigates the predetermined condition when a flow rate of the fluid is high as compared to when the flow rate of the fluid is low.

When the flow rate of the fluid is high, the decreasing rate of the oxygen storage amount of the catalyst is likely to be greater than when the flow rate of the fluid is low. Thus, as compared to when the flow rate is low, when the flow rate is high, an equivalent situation is not likely to occur in which the fluid to which the air-fuel ratio sensor is exposed is equivalent to the fluid to which the air-fuel ratio sensor is exposed when the air-fuel ratio of the mixture to be burned is the stoichiometric air-fuel ratio. This indicates that the above-described predetermined condition for determining the equivalent situation is less likely to be satisfied when the flow rate is high than when the flow rate is low. For this reason, when the detection value used as the input of the deviation amount calculation process needs to satisfy the predetermined condition, and the predetermined condition corresponding to when the flow rate is high is equivalent to the predetermined condition corresponding to when the flow rate is low, the number of samples of the detection value used as the input to the deviation amount calculation process may be excessively reduced when the flow rate is high. In this regard, in the above configuration, when the flow rate is high, the predetermined condition is mitigated as compared to when the flow rate is low. This reduces situations in which the number of samples of the detection value used as the input of the deviation amount calculation process is excessively decreased when the flow rate is high as compared to when the flow rate is low.

Aspect 5. In the controller according to any one of aspects 1 to 3, the deviation amount calculation process may include using, as an input, the detection value obtained when the detection value satisfies a predetermined condition. The processing circuitry may be configured to execute a maximum value calculation process that calculates a maximum value of the oxygen storage amount of the catalyst based on the detection value, and a condition variable process that mitigates the predetermined condition when the maximum value is small as compared to when the maximum value is large.

The maximum value of the amount of oxygen that can be stored in the catalyst may decrease due to age deterioration and the like. When the maximum value is small, the increasing rate of the amount of unburned fuel in the fluid flowing downstream of the catalyst is likely to be greater than when the maximum value is large. Thus, when the maximum value is small, the equivalent situation, in which the fluid to which the air-fuel ratio sensor is exposed is equivalent to the fluid to which the air-fuel ratio sensor is exposed when the air-fuel ratio of the mixture to be burned is the stoichiometric air-fuel ratio, is less likely to occur than when the maximum value is large. This indicates that the above-described predetermined condition for determining the equivalent situation is less likely to be satisfied when the maximum value is small than when the maximum value is large. For this reason, when the detection value used as the input of the deviation amount calculation process needs to satisfy the predetermined condition, and the predetermined condition corresponding to when the maximum value is large is equivalent to the predetermined condition corresponding to when the maximum value is small, the number of samples of the detection value as the input of the deviation amount calculation process may be excessively reduced when the maximum value is small. In this regard, in the above configuration, when the maximum value is small, the predetermined condition is mitigated as compared to when the maximum value is large. This reduces situations in which the number of samples of the detection value used as the input of the deviation amount calculation process is excessively reduced when the maximum value is small as compared to when the maximum value is large.

Aspect 6. In the controller according to any one of aspects 1 to 5, the processing circuitry may be configured to execute a limiting process that limits an amount of change in an output of the internal combustion engine so that when the detection value is acquired as an input of the deviation amount calculation process, an absolute value of the amount of change in the output of the internal combustion engine is decreased as compared to when the detection value is not acquired as an input of the deviation amount calculation process.

The absolute value of the amount of change in the detection value of the air-fuel ratio sensor is likely to be greater when the output fluctuation amount of the internal combustion engine is large than when it is small. In this regard, in the above-described configuration, when acquiring the detection value as the input for deviation amount calculation process, the output of the internal combustion engine is regulated so that the absolute value of the amount of change in the output of the internal combustion engine is decreased. This limits the fluctuation of the detection value of the air-fuel ratio sensor caused by the fluctuation of the output of the internal combustion engine.

Aspect 7. In the controller according to any one of aspects 1 to 6, the processing circuitry may be configured to execute a lean control process that is triggered when a detection value of the air-fuel ratio sensor is less than or equal to a rich determination value. The detection value of the air-fuel ratio sensor being equal to the rich determination value indicates that an air-fuel ratio is richer than a stoichiometric air-fuel ratio. The lean control process may include performing control with operation of the fuel injection valve so that a fluid flowing into the catalyst contains an amount of oxygen that is greater than an ideal amount of oxygen reacting with all of the unburned fuel contained in the fluid. The processing circuitry may be configured to execute a deviation amount reflection process that reflects the deviation amount indication value on the lean control process. The inflow process may include a rich control process triggered when a detection value of the air-fuel ratio sensor is greater than or equal to a lean determination value. The detection value of the air-fuel ratio sensor being equal to the lean determination value indicates that an air-fuel ratio is leaner than a stoichiometric air-fuel ratio. The rich control process may include performing control with operation of the fuel injection valve so that a fluid flowing into the catalyst contains an amount of unburned fuel that is greater than an ideal amount of unburned fuel reacting with all of the oxygen contained in the fluid. The deviation amount reflection process may include a process that sets a first switching timing at which the rich control process is switched to the lean control process when the deviation amount indication value indicates a lean side deviation amount. A second switching timing is an assumed timing at which the rich control process is switched to the lean control process when the deviation amount indication value is not reflected on the lean control process. The first switching timing may be set to be earlier than the second switching timing.

When the detection value is greater than or equal to the lean determination value, it may be considered that the amount of stored oxygen is greater than or equal to a predetermined amount. Thus, in the above configuration, the rich control process is triggered when the detection value is greater than or equal to the lean determination value.

When the detection value of the air-fuel ratio sensor has a lean side deviation, the timing at which the detection value becomes less than or equal to the rich determination value is delayed as compared to when the detection value does not have a lean side deviation. In this regard, in the above configuration, the deviation amount reflection process is executed. This allows the timing for switching from the rich control process to the lean control process when the detection value of the air-fuel ratio sensor has a lean side deviation to be even closer to the timing for switching from the rich control process to the lean control process when the detection value of the air-fuel ratio sensor does not have a lean side deviation.

Aspect 8. In the controller according to aspect 1, the processing circuitry may be configured to execute a rich control process when the oxygen storage amount of the catalyst is greater than or equal to a predetermined amount. The rich control process may include operating the fuel injection valve to cause a fluid containing oxygen and unburned fuel to flow into the catalyst, and an amount of the unburned fuel is greater than an ideal amount of unburned fuel that reacts with all of the oxygen. The processing circuitry may be configured to execute a deviation amount calculation process that calculates a deviation amount indication value that indicates a deviation amount of a detection value of the air-fuel ratio sensor based on a detection value of the air-fuel ratio sensor obtained during an execution of the rich control process. A time taken in the rich control process to decrease the oxygen storage amount of the catalyst from a maximum value to zero is a taken time. The deviation amount calculation process may include a process that changes the deviation amount indication value in accordance with a length of the taken time even when the detection value is the same.

When the oxygen storage amount of the catalyst is greater than or equal to the predetermined amount, the fluid containing oxygen and unburned fuel may flow into the catalyst. In this case, the portion of unburned fuel contained in the fluid and exceeding the ideal amount of unburned fuel that reacts with all of the oxygen will react with oxygen stored in the catalyst. Thus, the unburned fuel flowing downstream of the catalyst is negligible. In addition, the amount of oxygen in the fluid is less than the ideal amount of oxygen that reacts with all of the unburned fuel in the fluid. Thus, the amount of oxygen flowing out downstream of the catalyst is also negligible. Therefore, as described above, in a case in which the rich control process is started when the oxygen storage amount is greater than or equal to the predetermined amount, the amount of oxygen and the amount of unburned fuel in the fluid flowing out downstream of the catalyst are negligible. Thus, the fluid to which the air-fuel ratio sensor is exposed when the rich control process is executed in the above configuration is equivalent to the fluid to which the air-fuel ratio sensor is exposed when the air-fuel ratio of the mixture to be burned is the stoichiometric air-fuel ratio. This allows the deviation amount indication value to be calculated based on the deviation amount from the detection value assumed when the air-fuel ratio of the mixture to be burned is the stoichiometric air-fuel ratio. In the above configuration, the deviation amount of the detection value of the air-fuel ratio sensor is recognized, and hence the deviation may be resolved.

However, the detection value obtained when the rich control process is executed in accordance with the length of the taken time is likely to vary. The deviation amount indication value calculated when the taken time is long is likely to differ from the deviation amount indication value calculated when the taken time is short. Thus, in the above-described configuration, mapping that links the detection value that is input to the deviation amount calculation process with the output of the deviation amount calculation process is changed in accordance with the length of taken time. If the same detection value is given, the deviation amount indication value is calculated to be different values in accordance with the length of the taken time. As a result, the deviation amount indication value is calculated with higher accuracy as compared to a configuration that does not change the mapping in accordance with the length of the taken time.

Aspect 9. In the controller according to aspect 8, a flow rate of a fluid flowing into the catalyst during an execution of the rich control process is a rich control process flow rate. The deviation amount calculation process may include a change process that changes the deviation amount indication value based on the taken time being shorter when the rich control process flow rate is high than when the rich control process flow rate is low. The change process may include changing the deviation amount indication value in accordance with the rich control process flow rate even when the detection value is the same.

The flow rate of the fluid flowing into the catalyst when the rich control process is executed is referred to as the rich control process flow rate. When the rich control process flow rate is high, the amount of oxygen in the catalyst that reacts with the unburned fuel in the fluid per unit time is greater than when the rich control process flow rate is low. Thus, when the rich control process flow rate is high, the decreasing rate of the oxygen storage amount is increased, and the taken time shortens. In this case, since the increasing rate of the amount of unburned fuel flowing downstream of the catalyst increases, the detection value during execution of the rich control process is likely to differ between when the flow rate of the fluid is high and when the flow rate of the fluid is low. In this regard, in the above configuration, the deviation amount indication value is calculated in accordance with the flow rate. Thus, the deviation amount indication value is calculated taking into consideration that the detection value is affected by the flow rate. Ultimately, the deviation amount indication value is set to an even more appropriate value indicating the deviation amount.

Aspect 10. In the controller according to aspect 8 or 9, the processing circuitry may be configured to execute a maximum storage amount learning process that learns a maximum value of the oxygen storage amount of the catalyst. The deviation amount calculation process may include a change process that changes the deviation amount indication value based on the taken time being shorter when the maximum value is small than when the maximum value is large. The change process may include changing the deviation amount indication value in accordance with the maximum value even when the detection value is the same.

When the maximum value of the oxygen storage amount is small, the time taken in the rich control process for the oxygen storage amount of the catalyst to become zero is shorter than when the maximum value of the oxygen storage amount is large. When the maximum value of the oxygen storage amount is small, the increasing rate of the amount of unburned fuel flowing downstream of the catalyst increases. Thus, the detection value obtained when the maximum value of the oxygen storage amount is large and the rich control process is executed is likely to differ from the detection value obtained when the maximum value of the oxygen storage amount is small and the rich control process is executed. In this regard, in the above configuration, the deviation amount indication value is calculated in accordance with the maximum value of the oxygen storage amount. Thus, the deviation amount indication value is calculated taking into consideration that the detection value is affected by the maximum value of the oxygen storage amount. Ultimately, the deviation amount indication value is set to an even more appropriate value indicating the deviation amount.

Aspect 11. In the controller according to any one of aspects 8 to 10, the processing circuitry may be configured to execute a lean control process that is triggered when a detection value of the air-fuel ratio sensor is less than or equal to a rich determination value during an execution of the rich control process. The detection value of the air-fuel ratio sensor being equal to the rich determination value indicates that an air-fuel ratio is richer than a stoichiometric air-fuel ratio. The lean control process may include performing control so that a fluid flowing into the catalyst contains an amount of oxygen that is greater than an ideal amount of oxygen reacting with all of the unburned fuel contained in the fluid. The rich control process may be triggered when a detection value of the air-fuel ratio sensor is greater than or equal to a lean determination value during an execution of the lean control process. The detection value of the air-fuel ratio sensor being equal to the lean determination value indicates that an air-fuel ratio is leaner than a stoichiometric air-fuel ratio. The detection value is one of multiple detection values. The deviation amount calculation process may include a simple average process that calculates a simple average process value of the multiple detection values in a single period in which the rich control process is executed, an exponential moving average process using the simple average process value as an input, an update process that updates the deviation amount indication value through the exponential moving average process in accordance with a cycle in which the rich control process and the lean control process are executed, and a correction process that corrects the simple average process value in accordance with the length of the taken time. The correction process may allow the deviation amount indication value to be changed in accordance with the length of the taken time even when the detection values are the same.

When the detection value is greater than or equal to the lean determination value, it may be considered that the amount of stored oxygen is greater than or equal to a predetermined amount. Thus, in the above configuration, the rich control process is triggered when the detection value is greater than or equal to the lean determination value. In addition, in the above configuration, the simple average process value is corrected in accordance with the length of the taken time. The simple average process value is calculated based on multiple detection values sampled during the period of a single rich control process. Thus, it may be considered that the simple average process value is calculated based on a group of detection values obtained in a period in which the fluid flows into the catalyst at the same flow rate. Thus, in the above-described configuration according to aspect 9, the correction is even more appropriately performed in accordance with the differences in flow rate as compared to, for example, a configuration in which an exponential moving average process value is corrected.

Aspect 12. In the controller according to any one of aspects 8 to 11, the processing circuitry may be configured to execute a lean control process that is triggered when a detection value of the air-fuel ratio sensor is less than or equal to a rich determination value during an execution of the rich control process. The detection value of the air-fuel ratio sensor being equal to the rich determination value indicates that an air-fuel ratio is richer than a stoichiometric air-fuel ratio. The lean control process may include performing control so that a fluid flowing into the catalyst contains an amount of oxygen that is greater than an ideal amount of oxygen reacting with all of the unburned fuel contained in the fluid.

The processing circuitry may be configured to execute a deviation amount reflection process that reflects the deviation amount indication value on the lean control process. The rich control process may be triggered when a detection value of the air-fuel ratio sensor is greater than or equal to a lean determination value during an execution of the lean control process. The detection value of the air-fuel ratio sensor being equal to the lean determination value indicates that an air-fuel ratio is leaner than a stoichiometric air-fuel ratio. The deviation amount reflection process may include a process that sets a first switching timing at which the rich control process is switched to the lean control process when the deviation amount indication value indicates a lean side deviation amount. A second switching timing is an assumed timing at which the rich control process is switched to the lean control process when the deviation amount indication value is not reflected on the lean control process. The first switching timing may be set to be earlier than the second switching timing.

When the detection value is greater than or equal to the lean determination value, it may be considered that the amount of stored oxygen is greater than or equal to a predetermined amount. Thus, in the above configuration, the rich control process is triggered when the detection value is greater than or equal to the lean determination value.

When the detection value of the air-fuel ratio sensor has a lean side deviation, the timing at which the detection value becomes less than or equal to the rich determination value is delayed as compared to when the detection value does not have a lean side deviation. In this regard, in the above configuration, the deviation amount reflection process is executed. This allows the timing for switching from the rich control process to the lean control process when the detection value of the air-fuel ratio sensor has a lean side deviation to be even closer to the timing for switching from the rich control process to the lean control process when the detection value of the air-fuel ratio sensor does not have a lean side deviation.

Aspect 13. In the controller according to aspect 1, the detection value is one of multiple detection values. The deviation amount calculation process may include a process that calculates the deviation amount through an average process that averages the multiple detection values of the air-fuel ratio sensor obtained during an execution of the inflow process.

When the oxygen storage amount of the catalyst is greater than or equal to the predetermined amount, the predetermined fluid containing oxygen and unburned fuel may flow into the catalyst. In this case, even when the predetermined fluid contains unburned fuel in an amount greater than an ideal amount of unburned fuel that reacts with all of the oxygen contained in the fluid, the excess unburned fuel will react with oxygen stored in the catalyst. Thus, unburned fuel flowing downstream of the catalyst is negligible. In addition, since the amount of oxygen in the predetermined fluid is less than or equal to the ideal amount of oxygen that reacts with all of the unburned fuel in the predetermined fluid, the amount of oxygen flowing downstream of the catalyst is also negligible. Therefore, as described above, in a case in which the inflow process is started when the oxygen storage amount is greater than or equal to the predetermined amount, the amount of oxygen and the amount of unburned fuel in the fluid flowing out downstream of the catalyst are negligible. Therefore, the fluid to which the air-fuel ratio sensor is exposed during execution of the inflow process in the above configuration is equivalent to the fluid to which the air-fuel ratio sensor is exposed when the air-fuel ratio of the mixture to be burned is the stoichiometric air-fuel ratio. Thus, the deviation amount indication value may be calculated based on the deviation amount from the detection value assumed when the air-fuel ratio of the mixture to be burned is the stoichiometric air-fuel ratio. With the above configuration, the deviation of the detection value of the air-fuel ratio sensor is recognized, and hence the deviation may be resolved.

Particularly, in the above configuration, the deviation amount indication value is calculated by the average process of multiple detection values. This reduces the effect of noise of each detection value imposed on the deviation amount indication value.

Aspect 14. In the controller according to aspect 13, the average process may include an exponential moving average process. The processing circuitry may be configured to execute a coefficient variable process that sets a smoothing coefficient of the exponential moving average process to a smaller value when the exponential moving average process is executed a small number of times than when the exponential moving average process is executed a large number of times.

When the number of times the exponential moving average process is executed is small, each detection value contributes to the exponential moving average process value at a greater proportion than when the number of times is large. Therefore, when the number of times the exponential moving average process is executed is small, the effect of noise contained in each detection value may be increased and imposed on the exponential moving average process value. Thus, in the above configuration, when the number of times of execution is small, the smoothing coefficient is set to a smaller value than when the number of times of execution is large. As a result, when the number of times of execution is small, the contribution proportion of each detection value to the deviation amount indication value may be decreased. This reduces the effect of noise contained in each detection value imposed on the exponential moving average process value.

Aspect 15. In the controller according to aspect 13 or 14, the average process may include an exponential moving average process. The processing circuitry may be configured to execute a coefficient variable process that sets a smoothing coefficient of the exponential moving average process to a smaller value when a small number of samples of the detection values is used for calculating the deviation amount than when a large number of samples of the detection values is used for calculating the deviation amount.

When the number of samples of the detection value is small, each detection value contributes to the exponential moving average process value at a greater proportion than when the number of samples is large. Therefore, when the number of samples of the detection value is small, the effect of noise contained in each detection value may be increased and imposed on the exponential moving average process value. Thus, in the above configuration, when the number of samples is small, the smoothing coefficient is set to a smaller value than when the number of samples is large, so that the contribution proportion of each detection value to the deviation amount indication value is decreased when the number of samples is small. This reduces the effect of noise contained in each detection value imposed on the exponential moving average process value.

Aspect 16. In the controller according to any one of aspects 13 to 15, the average process may include an exponential moving average process. When an absolute value of a difference between a deviation amount indicated by the deviation amount indication value and a deviation amount indicated by the detection value is greater than or equal to a predetermined value, the processing circuitry may be configured to execute a reduction process that reduces a contribution proportion of the detection value to the exponential moving average process.

When the absolute value of the difference between the deviation amount indicated by the deviation amount indication value and the deviation amount indicated by the detection value is large, the detection value may be greatly affected by incidental noise. Thus, in the above configuration, when the absolute value of the difference is large, the contribution proportion of each detection value to the exponential moving average process is decreased to reduce the effect of noise imposed on the deviation amount indication value.

Aspect 17. In the controller according to any one of aspects 13 to 16, the inflow process may include a rich control process that is triggered when a detection value of the air-fuel ratio sensor is greater than or equal to a lean determination value. The detection value of the air-fuel ratio sensor being equal to the lean determination value indicates that an air-fuel ratio is leaner than a stoichiometric air-fuel ratio. The rich control process may include performing control with operation of the fuel injection valve so that a fluid flowing into the catalyst contains an amount of unburned fuel that is greater than an ideal amount of unburned fuel reacting with all of the oxygen contained in the fluid. The processing circuitry may be configured to execute a lean control process that is triggered when a detection value of the air-fuel ratio sensor is less than or equal to a rich determination value. The detection value of the air-fuel ratio sensor being equal to the rich determination value indicates that an air-fuel ratio is richer than a stoichiometric air-fuel ratio. The lean control process may include performing control with operation of the fuel injection valve so that a fluid flowing into the catalyst contains an amount of oxygen that is greater than an ideal amount of oxygen reacting with all of the unburned fuel contained in the fluid. The deviation amount calculation process may include a simple average process that calculates a simple average process value of the multiple detection values in a single period in which the rich control process is executed, an exponential moving average process using the simple average process value as an input, and an update process that updates the deviation amount indication value through the exponential moving average process in accordance with a cycle in which the rich control process and the lean control process are executed.

When the detection value is greater than or equal to the lean determination value, it may be considered that the amount of stored oxygen is greater than or equal to a predetermined amount. Thus, in the above configuration, the inflow process is triggered when the detection value is greater than or equal to the lean determination value. In addition, in the above configuration, both the simple average process and the exponential moving average process are executed. This even more appropriately reduces the effect of noise as compared to when only one of the processes is executed.

Aspect 18. In the controller according to aspect 17, the processing circuitry may be configured to execute a coefficient variable process that sets a smoothing coefficient of the exponential moving average process to a smaller value when a small number of samples of the detection values is used in the simple average process than when a large number of samples of the detection values is used in the simple average process.

When the number of samples of detection values used in the simple average process is small, each detection value contributes to the simple average process at a greater proportion than when the number of samples is large. Thus, when the number of samples is small, the effect of noise contained in each detection value is also increased. Thus, in the above configuration, the smoothing coefficient is decreased when the number of samples of detection values used in the simple average process is small. This reduces the contribution proportion of each detection value to the exponential moving average process value. As a result, the effect of noise contained in each detection value imposed on the deviation amount indication value is reduced.

Aspect 19. In the controller according to aspect 17 or 18, the processing circuitry may be configured to execute a coefficient variable process that sets a smoothing coefficient of the exponential moving average process to a smaller value when an absolute value of a difference between the simple average process value used as an input of the exponential moving average process and an exponential moving average process value is large than when the absolute value of the difference is small.

When the difference between the simple average process value and the exponential moving average process value is large, each detection value may not indicate a stable value and may be greatly affected by noise as compared to when the difference is small. Thus, in the above configuration, the smoothing coefficient is set to a smaller value when the difference between the simple average process value and the exponential moving average process value is large than when it is small. This reduces an amount of the exponential moving average process value updated by one simple average process. Ultimately, the effect of noise contained in each detection value imposed on the deviation amount indication value calculated by the exponential moving average process may be reduced.

Aspect 20. In the controller according to any one of aspects 13 to 19, the inflow process may include a rich control process that is triggered when a detection value of the air-fuel ratio sensor is greater than or equal to a lean determination value. The detection value of the air-fuel ratio sensor being equal to the lean determination value indicates that an air-fuel ratio is leaner than a stoichiometric air-fuel ratio. The rich control process may include performing control with operation of the fuel injection valve so that a fluid flowing into the catalyst contains an amount of unburned fuel that is greater than an ideal amount of unburned fuel reacting with all of the oxygen contained in the fluid. The processing circuitry may be configured to execute a lean control process that is triggered when a detection value of the air-fuel ratio sensor is less than or equal to a rich determination value. The detection value of the air-fuel ratio sensor being equal to the rich determination value indicates that an air-fuel ratio is richer than a stoichiometric air-fuel ratio. The lean control process may include performing control with operation of the fuel injection valve so that a fluid flowing into the catalyst contains an amount of oxygen that is greater than an ideal amount of oxygen reacting with all of the unburned fuel contained in the fluid. The processing circuitry may be configured to execute a deviation amount reflection process that reflects the deviation amount indication value on the lean control process. The deviation amount reflection process may include a process that sets a first switching timing at which the rich control process is switched to the lean control process when the deviation amount indication value indicates a lean side deviation amount. A second switching timing is an assumed timing at which the rich control process is switched to the lean control process when the deviation amount indication value is not reflected on the lean control process. The first switching timing may be set to be earlier than the second switching timing.

When the detection value is greater than or equal to the lean determination value, it may be considered that the amount of stored oxygen is greater than or equal to a predetermined amount. Thus, in the above configuration, the rich control process is triggered when the detection value is greater than or equal to the lean determination value.

When the detection value of the air-fuel ratio sensor has a lean side deviation, the timing at which the detection value becomes richer than the predetermined value is delayed as compared to when the detection value does not have a lean side deviation. In this regard, in the above configuration, the deviation amount reflection process is executed. This allows the timing for switching from the rich control process to the lean control process when the detection value of the air-fuel ratio sensor has a lean side deviation to be even closer to the timing for switching from the rich control process to the lean control process when the detection value of the air-fuel ratio sensor does not have a lean side deviation.

Aspect 21. An aspect of the present disclosure provides a controller for an internal combustion engine that includes a fuel injection valve, a catalyst provided in an exhaust passage and capable of storing oxygen, and an air-fuel ratio sensor provided downstream of the catalyst in the exhaust passage. The controller includes processing circuitry. The processing circuitry is configured to execute an air-fuel ratio control process that operates the fuel injection valve to control an air-fuel ratio of a mixture in a combustion chamber of the internal combustion engine to a target value. The processing circuitry is configured to execute a rich control process that is triggered when a detection value of the air-fuel ratio sensor is greater than or equal to a lean determination value. The detection value of the air-fuel ratio sensor being equal to the lean determination value indicates that an air-fuel ratio is leaner than a stoichiometric air-fuel ratio. The rich control process includes setting the target value to be richer than the stoichiometric air-fuel ratio. The processing circuitry is configured to execute a lean control process that is triggered when the detection value of the air-fuel ratio sensor is less than or equal to a rich determination value. The detection value of the air-fuel ratio sensor being equal to the rich determination value indicates that the air-fuel ratio is richer than the stoichiometric air-fuel ratio. The lean control process includes setting the target value to be leaner than the stoichiometric air-fuel ratio. The processing circuitry is configured to execute a deviation amount calculation process when an execution condition of a process that calculates a deviation amount indication value indicating a deviation amount of a detection value of the air-fuel ratio sensor is satisfied. The deviation amount calculation process includes calculating the deviation amount indication value based on a detection value of the air-fuel ratio sensor obtained during an execution of the rich control process. The processing circuitry is configured to execute a variable process that variably sets at least one of the target value set by the rich control process or the target value set by the lean control process. The target value variably set when the execution condition is satisfied differs from the target value variably set when the execution condition is not satisfied.

It can be considered that when the detection value of the air-fuel ratio sensor is leaner than the stoichiometric air-fuel ratio, the oxygen storage amount of the catalyst is greater than or equal to the predetermined amount. In a case in which the rich control process is triggered when the oxygen storage amount is greater than or equal to the predetermined amount, the portion of the unburned fuel in the fluid flowing into the catalyst exceeding the ideal amount of unburned fuel that reacts with all of the oxygen in the fluid reacts with the oxygen stored in the catalyst. Thus, unburned fuel flowing out downstream of the catalyst is negligible. In addition, when the rich control process is executed, the amount of oxygen flowing out downstream of the catalyst is also negligible. Therefore, the fluid to which the air-fuel ratio sensor is exposed when the rich control process is executed is equivalent to the fluid to which the air-fuel ratio sensor is exposed when the air-fuel ratio of the mixture to be burned is the stoichiometric air-fuel ratio. Thus, the deviation amount indication value may be calculated based on the deviation amount from the detection value assumed when the air-fuel ratio of the mixture to be burned is the stoichiometric air-fuel ratio. With above configuration, the deviation of the detection value of the air-fuel ratio sensor is recognized, and hence the deviation may be resolved.

In addition, the above configuration executes the variable process so that at least one of the lean control process or the rich control process is adjusted to be more appropriate to the deviation amount calculation process. Therefore, when acquiring the detection value that is input to the deviation amount calculation process, at least one of the lean control process or the rich control process is adjusted to be more appropriate for acquiring the detection value.

Aspect 22. In the controller according to aspect 21, the variable process may include a process that sets the target value set by the rich control process to be closer to the stoichiometric air-fuel ratio when the deviation amount calculation process is executed than when the deviation amount calculation process is not executed.

When the target value set by the rich control process is set to be closer to the stoichiometric air-fuel ratio, the timing for switching from the rich control process to the lean control process is delayed as compared to when the target value is not set to be closer to the stoichiometric air-fuel ratio. This prolongs the duration of the rich control process. In this regard, in the above configuration, the variable process is executed to prolong the duration of the rich control process as compared to when the variable process is not executed This ensures a sufficient time for acquiring the detection value that is input to the deviation amount calculation process.

Aspect 23. In the controller according to aspect 22, the detection value is one of multiple detection values detected while the rich control process is continued. The deviation amount calculation process may include a process that uses the multiple detection values in a single updating process of the deviation amount indication value.

In the above configuration, a single updating process of the deviation amount indication value is executed based on multiple detection values. Hence, the process of aspect 22 is particularly advantageous when prolonging the duration of the rich control process.

Aspect 24. In the controller according to any one of aspects 21 to 23, the variable process may include a process that sets the target value set by the lean control process to be leaner when the execution condition is satisfied than when the execution condition is not satisfied.

When the target value set by the lean control process is set to be leaner, the timing for switching from the lean control process to the rich control process is advanced as compared to when the target value is not set to be leaner. This shortens the duration of the lean control process. In this regard, in the above configuration, the variable process is executed to shorten the duration of the lean control process as compared to when the variable process is not executed. This increases the proportion of a period for acquiring a detection value that is input to the deviation amount calculation process in a period in which the internal combustion engine runs.

Aspect 25. In the controller according to any one of aspects 21 to 24, the air-fuel ratio sensor may be a downstream air-fuel ratio sensor. The internal combustion engine may include an upstream air-fuel ratio sensor provided upstream of the catalyst. The air-fuel ratio control process may include a process that feedback-controls a detection value of the upstream air-fuel ratio sensor to the target value.

In the above configuration, the air-fuel ratio control process uses feedback control. This improves the controllability of the air-fuel ratio of the mixture as compared to a configuration that uses only open loop control.

Aspect 26. In the controller according to any one of aspects 21 to 25, the processing circuitry may be configured to execute a deviation amount reflection process that reflects the deviation amount indication value on the lean control process. The deviation amount reflection process may include a process that sets a first switching timing at which the rich control process is switched to the lean control process when the deviation amount indication value indicates a lean side deviation amount. A second switching timing is an assumed timing at which the rich control process is switched to the lean control process when the deviation amount indication value is not reflected on the lean control process. The first switching timing may be set to be earlier than the second switching timing.

When the detection value of the air-fuel ratio sensor has a lean side deviation, the timing at which the detection value becomes less than or equal to the rich determination value is delayed as compared to when the detection value does not have a lean side deviation. In this regard, in the above configuration, the deviation amount reflection process is executed. This allows the timing for switching from the rich control process to the lean control process when the detection value of the air-fuel ratio sensor has a lean side deviation to be even closer to the timing for switching from the rich control process to the lean control process when the detection value of the air-fuel ratio sensor does not have a lean side deviation.

Other features and aspects will be apparent from the following detailed description, the drawings, and the claims.

### BRIEF DESCRIPTION OF THE DRAWINGS

FIG. 1 is a diagram showing a controller and a drive system of a vehicle according to a first embodiment.

FIG. 2 is a block diagram showing processes executed by the controller according to the first embodiment.

FIG. 3 is a flowchart showing a procedure of a sub-feedback process according to the first embodiment.

FIG. 4 is a flowchart showing a procedure of a stoichiometric point calculation process according to the first embodiment.

FIG. 5 is a time chart for showing a sampling method of a detection value for calculating a stoichiometric point according to the first embodiment.

FIG. 6 is a flowchart showing a procedure of a stoichiometric point calculation process according to a second embodiment.

FIG. 7 is a flowchart showing a procedure of a stoichiometric point calculation process according to a third embodiment.

FIG. 8 is a flowchart showing a procedure of a stoichiometric point calculation process according to a fourth embodiment.

FIG. 9 is a flowchart showing a procedure of a stoichiometric point calculation process according to a fifth embodiment.

FIGS. 10A and 10B are time charts showing a sampling method of a detection value for calculating a stoichiometric point according to the fifth embodiment.

FIG. 11 is a block diagram showing processes executed by a controller according to a sixth embodiment.

FIG. 12 is a flowchart showing a procedure of a stoichiometric point calculation process according to a seventh embodiment.

FIG. 13 is a flowchart showing a procedure of a stoichiometric point calculation process according to an eighth embodiment.

FIG. 14 is a flowchart showing a procedure of a stoichiometric point calculation process according to a ninth embodiment.

FIG. 15 is a flowchart showing a procedure of a stoichiometric point calculation process according to a tenth embodiment.

FIG. 16 is a flowchart showing a procedure of a stoichiometric point calculation process according to an eleventh embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

Hereinafter, a first embodiment according to a controller for an internal combustion engine will be described with reference to the drawings.

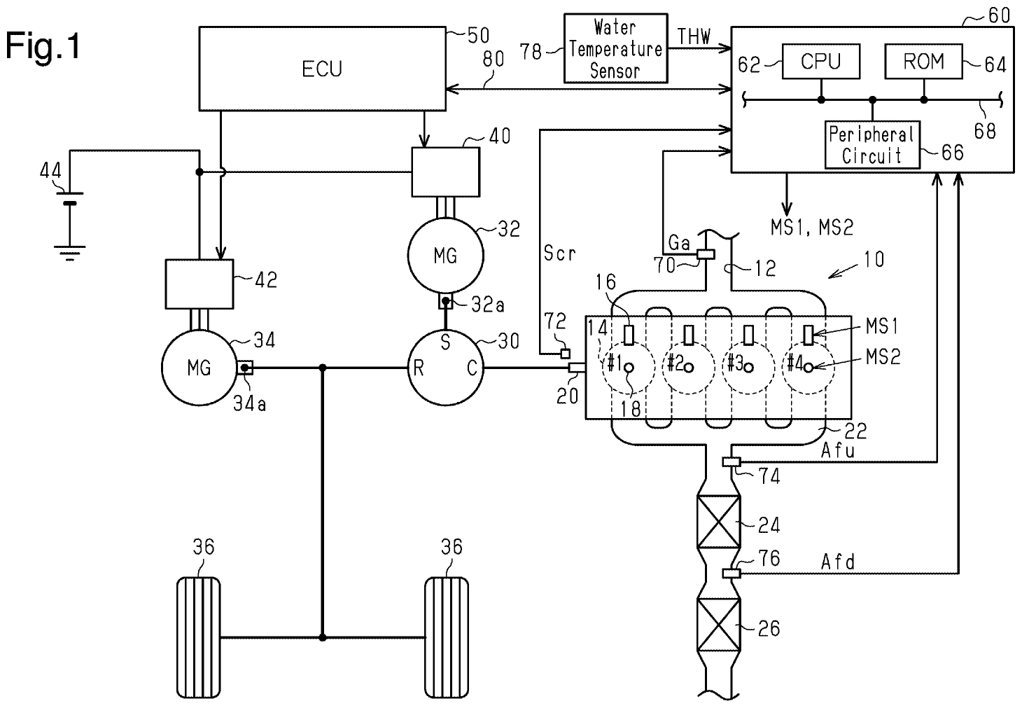

In an internal combustion engine 10 shown in FIG. 1, air drawn from an intake passage 12 flows into combustion chambers 14 of cylinders #1 to #4. In each combustion chamber 14, the mixture of fuel injected from a fuel injection valve 16 with the air flowing in from the intake passage 12 is subjected to combustion by spark discharge of an igniter 18, and energy generated by the combustion is converted into rotational energy of a crankshaft 20. The mixture used in the combustion is discharged to an exhaust passage 22 as exhaust gas. The exhaust passage 22 is provided with an upstream three-way catalyst 24 and a downstream three-way catalyst 26. The three-way catalysts 24 and 26 are capable of storing oxygen.

The crankshaft 20 is mechanically connected to a carrier C of a planetary gear mechanism 30 that configures a power split mechanism. The planetary gear mechanism 30 includes a sun gear S mechanically connected to a rotation shaft 32a of a motor generator 32. The planetary gear mechanism 30 includes a ring gear R mechanically connected to a rotation shaft 34a of a motor generator 34 and drive wheels 36. Thus, the internal combustion engine 10 of the present embodiment is a drive source of a series-parallel hybrid vehicle.

The motor generator 32 is supplied with electric power from a battery 44 through an inverter 40. The motor generator 34 is supplied with electric power from the battery 44 through an inverter 42.

An ECU 50 is a controller that controls the motor generators 32 and 34 and executes processes controlling amounts, such as torque and rotational speed, of the motor generators 32 and 34. In addition, the ECU 50 controls the internal combustion engine 10 and the motor generators 32 and 34 to execute a process for generating an output that is requested in cooperation with the internal combustion engine 10 and the motor generators 32 and 34.

A controller 60 controls the internal combustion engine 10 and operates operation units, such as the fuel injection valves 16 and the igniters 18, of the internal combustion engine 10 in order to control the engine aspects such as torque and an exhaust component ratio of the internal combustion engine 10. More specifically, for example, the controller 60 sends operation signals MS1 to the fuel injection valves 16 to operate the fuel injection valves 16 and operation signals MS2 to the igniters 18 to operate the igniters 18.

In order to control the aspects, the controller 60 refers to an intake air amount Ga that is detected by an air flow meter 70, an output signal Scr of a crank angle sensor 72, and a detection value Afu that is detected by an upstream air-fuel ratio sensor 74 provided upstream of the three-way catalyst 24. The controller 60 also refers to a detection value Afd that is detected by a downstream air-fuel ratio sensor 76 provided at a side downstream of the three-way catalyst 24 and upstream of the three-way catalyst 26, and the temperature (water temperature THW) of coolant in the internal combustion engine 10 that is detected by a water temperature sensor 78. The upstream air-fuel ratio sensor 74 and the downstream air-fuel ratio sensor 76 are not oxygen sensors having Z-characteristics but are sensors that linearly increase a detection value as the amount of oxygen exceeding the amount of unburned fuel in the exhaust is increased. Further, the controller 60 is used to communicate with the ECU 50 through a communication line 80.

The controller 60 includes a CPU 62, a ROM 64, and a peripheral circuit 66 that are connected by a communication line 68. The peripheral circuit 66 includes a circuit that generates a clock signal specifying an internal operation, a power supply circuit, a reset circuit, and the like.

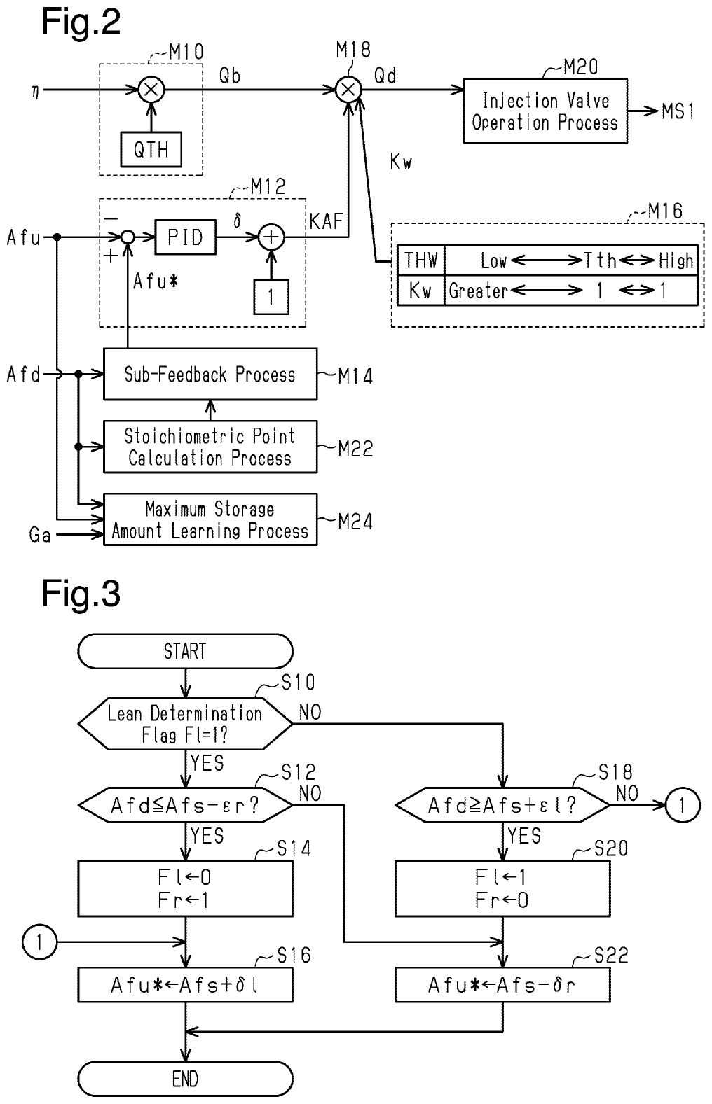

FIG. 2 shows processes executed by the controller 60. The processes shown in FIG. 2 are implemented by the CPU 62 executing programs stored in the ROM 64.

A base injection amount calculation process M10 calculates a base injection amount Qb, which is a base value of an amount of fuel determined based on a charging efficiency η so that the air-fuel ratio of the mixture in the combustion chamber 14 reaches the target air-fuel ratio. Specifically, for example, when the charging efficiency η is expressed in a percentage, the base injection amount calculation process M10 may calculate the base injection amount Qb by multiplying the charging efficiency η by a fuel amount QTH per 1% of the charging efficiency η for setting the air-fuel ratio to the target air-fuel ratio. The base injection amount Qb is an amount of fuel calculated so that the air-fuel ratio is controlled to be the target air-fuel ratio based on the amount of air charged into the combustion chamber 14. In the present embodiment, the target air-fuel ratio is the stoichiometric air-fuel ratio. The charging efficiency η is calculated by the CPU 62 based on the intake air amount Ga and a rotational speed NE. The rotational speed NE is calculated by the CPU 62 based on the output signal Scr.

A main feedback process M12 calculates and outputs a feedback correction coefficient KAF, which is obtained by adding one to a correction ratio δ of the base injection amount Qb as a feedback operation amount. The feedback operation amount is an operation amount for feedback control that controls the detection value Afu of the upstream air-fuel ratio sensor 74 to a target value Afu*. Specifically, in the main feedback process M12, the correction ratio δ is a sum of output values of a proportional element and a differential element into which the difference between the detection value Afu and the target value Afu* is input, and an output value of an integral element that holds and outputs an integrated value of the value corresponding to the difference.

A sub-feedback process M14 operates the target value Afu* to adjust the oxygen storage amount of the three-way catalyst 24 based on the detection value Afd of the downstream air-fuel ratio sensor 76.

When the water temperature THW is less than a predetermined temperature Tth (for example, 60° C.), a low temperature correction process M16 calculates a low temperature increase coefficient Kw to be a value greater than one to increase the base injection amount Qb. Specifically, when the water temperature THW is low, the low temperature increase coefficient Kw is calculated to be greater than when the water temperature THW is high. When the water temperature THW is greater than or equal to the predetermined temperature Tth, the low temperature increase coefficient Kw is set to one so that a correction amount of the base injection amount Qb corresponding to the low temperature increase coefficient Kw is zero.

A request injection amount calculation process M18 multiplies the base injection amount Qb by the feedback correction coefficient KAF and the low temperature increase coefficient Kw to calculate the amount of fuel requested (request injection amount Qd) in a single combustion cycle.

An injection valve operation process M20 sends the operation signal MS1 to the fuel injection valve 16 in order to operate the fuel injection valve 16. In particular, the injection valve operation process M20 is a process that injects the request injection amount Qd of fuel from the fuel injection valve 16 in a single combustion cycle.

When the air-fuel ratio of the mixture to be burned in the combustion chamber 14 is the stoichiometric air-fuel ratio, a stoichiometric point calculation process M22 calculates the detection value Afd of the downstream air-fuel ratio sensor 76 as a stoichiometric point AfL.

A maximum storage amount learning process M24 learns a maximum value OSmax of an oxygen storage amount OS of the three-way catalyst 24 based on the detection value Afu of the upstream air-fuel ratio sensor 74 and the detection value Afd of the downstream air-fuel ratio sensor 76. Specifically, the fuel injection valve 16 is operated so that the detection value Afu becomes lean, which is triggered when the detection value Afd is switched from lean to rich. The maximum value OSmax of the oxygen storage amount OS is calculated based on the amount of oxygen that flows into the three-way catalyst 24 from the switching of the detection value Afd to rich until the detection value Afd is switched to lean. Specifically, the maximum storage amount learning process M24 includes a process that calculates the flow rate of oxygen flowing into the three-way catalyst 24 based on the detection value Afu and the intake air amount Ga.

FIG. 3 shows the procedure of the sub-feedback process M14. The process shown in FIG. 3 is implemented by the CPU 62 repeatedly executing programs stored in the ROM 64, for example, in a predetermined cycle. In the description below, the step number of each process is represented by a numeral provided with S in front.

In the series of processes shown in FIG. 3, first, the CPU 62 determines whether a lean determination flag Fl is one (S10). When it is determined that the lean determination flag Fl is one (S10: YES), the CPU 62 determines whether the detection value Afd is less than or equal to a value obtained by subtracting a rich side sub-offset amount εr from a stoichiometric reference value Afs (S12). The stoichiometric reference value Afs is a reference value (detection value of the air-fuel ratio sensor as a reference) of the detection value of the downstream air-fuel ratio sensor 76 obtained when the air-fuel ratio of the mixture subject to combustion in the combustion chamber 14 is the stoichiometric air-fuel ratio. The process of S12 determines whether the flow rate of unburned fuel in the fluid flowing downstream of the three-way catalyst 24 is increasing.

When it is determined that the detection value Afd is less than or equal to the value obtained by subtracting the rich side sub-offset amount εr from the stoichiometric reference value Afs (S12: YES), the CPU 62 assigns zero to the lean determination flag Fl and assigns one to a rich determination flag Fr (S14).

Next, the CPU 62 assigns a value obtained by adding a lean side main offset amount δl and the stoichiometric reference value Afs to the target value Afu* (S16).

When it is determined that the lean determination flag Fl is zero (S10: NO), the CPU 62 determines whether the detection value Afd is greater than or equal to a value obtained by adding a lean side sub-offset amountεl and the stoichiometric reference value Afs (S18). In this process, it is determined whether the flow rate of oxygen in the fluid flowing downstream of the three-way catalyst 24 is increasing as the amount of oxygen stored in the three-way catalyst 24 approaches the maximum value OSmax. When the CPU 62 determines that the detection value Adf is less than the value obtained by adding the lean side sub-offset amount εl and the stoichiometric reference value Afs (S18: NO), the CPU 62 proceeds to the process of S16.

When it is determined that the detection value Adf is greater than or equal to the value obtained by adding the lean side sub-offset amount εl and the stoichiometric reference value Afs (S18: YES), the CPU 62 sets the lean determination flag Fl to one and the rich determination flag Fr to zero (S20).

When the process of S20 is completed or the negative determination is made in the process of S12, the CPU 62 assigns a value obtained by subtracting a rich side main offset amount δr from the stoichiometric reference value Afs to the target value Afu* (S22).

The rich side sub-offset amount εr, the lean side sub-offset amount εl, the rich side main offset amount δr, and the lean side main offset amount δl are set to values that will not substantially change the oxygen storage amount of the three-way catalyst 24 in a cycle of the process of S16 and the process of S22.

When the process of S16 or the process of S22 is completed, the CPU 62 temporarily ends the series of processes shown in FIG. 3.

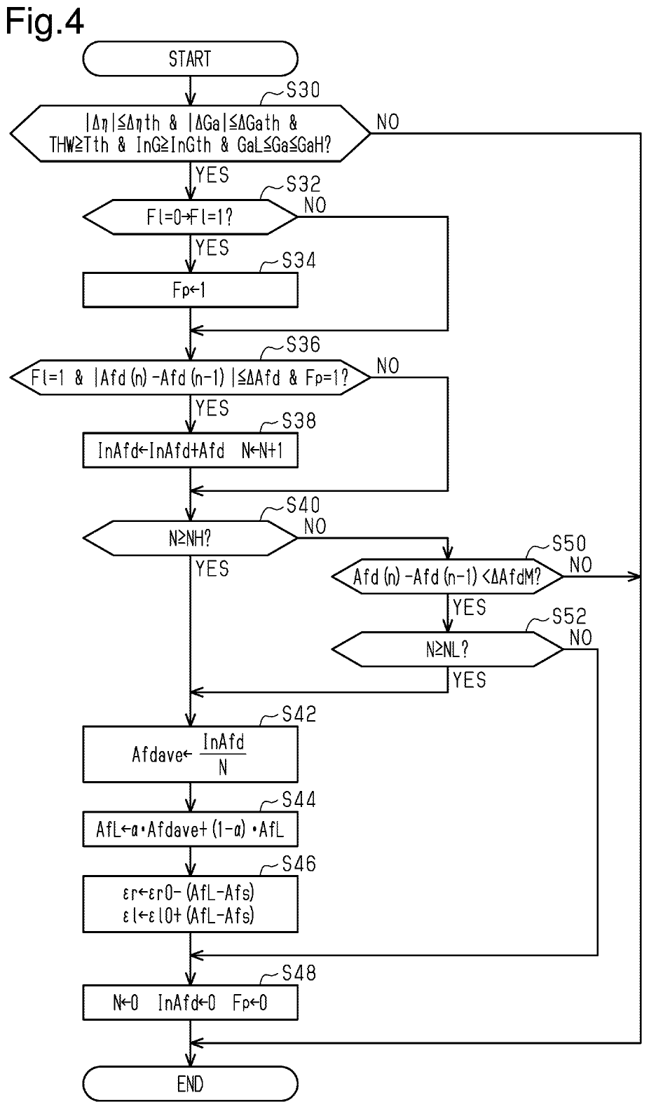

FIG. 4 shows the procedure of the stoichiometric point calculation process M22. The process shown in FIG. 4 is implemented by the CPU 62 repeatedly executing programs stored in the ROM 64, for example, in a predetermined cycle.

In the series of processes shown in FIG. 4, first, the CPU 62 determines whether the logical conjunction of the following conditions (A) to (E) is true (S30).

Condition (A) indicates that the absolute value of an amount of change Δη in the charging efficiency η in a predetermined period is less than or equal to a predetermined amount Δηth. The predetermined period may be, for example, a cycle of the series of processes shown in FIG. 4. In this case, the amount of change Δη may be the difference between a sampled value (current value) corresponding to the current execution cycle of the series of processes shown in FIG. 4 related to the charging efficiency η and a sampled value (previous value) corresponding to the previous execution cycle. This condition indicates that the absolute value of the amount of change in the fluid flowing into the three-way catalyst 24 in the predetermined period is less than or equal to the predetermined amount. This condition is provided taking into consideration that when the absolute value of the amount of change in the fluid flowing into the three-way catalyst 24 is large, the detection value Afd is likely to fluctuate as compared to when the absolute value of the amount of change is small.

Condition (B) indicates that the absolute value of an amount of change ΔGa in a predetermined period of the intake air amount Ga is less than or equal to a predetermined amount ΔGath. The predetermined period may be, for example, a cycle of the series of processes shown in FIG. 4. In this case, the amount of change ΔGa may be a difference between the current value of the intake air amount Ga and the previous value of the intake air amount Ga. This condition indicates that the absolute value of the amount of change in the fluid flowing into the three-way catalyst 24 in a predetermined period is less than or equal to the predetermined amount.

Condition (C) indicates that the water temperature THW is greater than or equal to the predetermined temperature Tth. This condition is provided to avoid a situation in which an error of the air-fuel ratio caused by the low temperature increase coefficient Kw, which is an open loop operation amount, affects the calculation of the stoichiometric point AfL.

Condition (D) indicates that an accumulated value InG of the intake air amount Ga from a start of the internal combustion engine 10 is greater than or equal to a predetermined value InGth. This condition indicates that the three-way catalyst 24 is at an active temperature.

Condition (E) indicates that the intake air amount Ga is greater than or equal to a lower limit value GaL and is less than or equal to an upper limit value GaH. The upper limit value GaH is set to an upper limit value at which the duration of the process of S22 will not be excessively short. The lower limit value GaL is set to a value corresponding to, for example, a time of idling.

When it is determined that the logical conjunction of the conditions (A) to (E) is true (S30: YES), the CPU 62 determines whether the lean determination flag Fl is switched from zero to one (S32). When it is determined that the value of the lean determination flag Fl is zero in the previous execution cycle of the series of processes shown in FIG. 4 and the value of the lean determination flag Fl is one in the current execution cycle (S32: YES), the CPU 62 assigns one to a permission flag Fp (S34).

When the process of S34 is completed or the negative determination is made in the process of S32, the CPU 62 determines whether the logical conjunction of the following conditions (F) to conditions (H) is true (S36).

Condition (F) indicates that the lean determination flag Fl is one. This process is a condition that when it is considered that the amount of oxygen stored in the three-way catalyst 24 is greater than or equal to the predetermined amount, the amount of unburned fuel in the fluid flowing into the three-way catalyst 24 is greater than the ideal amount of oxygen reacting with all of the unburned fuel. More specifically, the setting of the lean determination flag Fl to one is triggered when the detection value Afd becomes greater than the stoichiometric reference value Afs by the lean side sub-offset amount εl or more. Thus, when the lean determination flag Fl is one, it may be considered that sufficient oxygen is stored in the three-way catalyst 24. When the process of S22 is executed when the lean determination flag Fl is one, the fluid flowing into the three-way catalyst 24 includes an amount of unburned fuel that is greater than the ideal amount of unburned fuel reacting with all of the oxygen contained in the fluid.

Condition (G) indicates that the absolute value of the difference between the current detection value Afd and the previous detection value Afd is less than or equal to a specified amount ΔAfd. In FIG. 4, the current value is denoted by “n,” and the previous value is denoted by “n−1.”

This condition indicates that the amount of oxygen and the amount of unburned fuel in the fluid flowing out downstream of the three-way catalyst 24 are negligibly small. More specifically, after the process of S22 is started, it takes time for the detection value Afu of the upstream air-fuel ratio sensor 74 to reach the target value Afu* that is determined by the process of S22. During this time, the amount of oxygen in the fluid flowing into the three-way catalyst 24 decreases. Thus, in this period, the amount of oxygen in the fluid flowing out downstream of the three-way catalyst 24 gradually decreases, and thus the amount of change in the detection value Afd relatively increases. Subsequently, when the detection value Afu of the upstream air-fuel ratio sensor 74 converges and stabilizes on the target value Afu* determined by the process of S22, the absolute value of the amount of change in the detection value Afd of the downstream air-fuel ratio sensor 76 also decreases. The condition (G) specifies this point in time.

Condition (H) indicates that the permission flag Fp is one.

When it is determined that the logical conjunction of the above conditions (F) to (H) is true (S36: YES), the CPU 62 adds the current sampled value and an accumulated value InAfd of the detection value Afd to update the accumulated value InAfd and increments an accumulation count N of the detection value Afd (S38). When the process of S38 is completed or the negative determination is made in the process of S36, the CPU 62 determines whether the accumulation count N is greater than or equal to a reference count NH (S40). This process determines whether the stoichiometric point AfL is allowed to be updated using the accumulated value InAfd.

When it is determined that the accumulation count N is greater than or equal to the reference count NH (S40: YES), the CPU 62 assigns a value obtained by dividing the accumulated value InAfd by the accumulation count N to an average value Afdave in order to calculate a simple average process value of the detection value Afd (S42). Next, the CPU 62 calculates the stoichiometric point AfL through the exponential moving average process of the average value Afdave (S44). In this process, the stoichiometric point AfL is updated by the sum of a value obtained by multiplying a smoothing coefficient α by the average value Afdave and a value obtained by multiplying “1−α” by the stoichiometric point AfL, where the smoothing coefficient α has a value greater than zero and less than one. The initial value of the stoichiometric point AfL may be, for example, the stoichiometric reference value Afs.

Next, the CPU 62 subtracts a value obtained by subtracting the stoichiometric reference value Afs from the stoichiometric point AfL from an initial value εr0 of the rich side sub-offset amount εr. Also, the CPU 62 adds the value obtained by subtracting the stoichiometric reference value Afs from the stoichiometric point AfL and an initial value εl0 of the lean side sub-offset amount εl. This updates the rich side sub-offset amount εr and the lean side sub-offset amount εl (S46). When the stoichiometric point AfL is not calculated, in the process of FIG. 3, the initial value εr0 may be assigned to the rich side sub-offset amount εr, and the initial value εl0 may be assigned to the lean side sub-offset amount εl.

Then, the CPU 62 initializes the accumulation count N and the accumulated value InAfd, and assigns zero to the permission flag Fp (S48).

When the negative determination is made in the process of S40, the CPU 62 determines whether a value obtained by subtracting the previous detection value Afd from the current detection value Afd is less than a negative specified amount ΔAfdM (S50). This process determines whether the amount of oxygen stored in the three-way catalyst 24 has decreased and the unburned fuel in the fluid flowing into the three-way catalyst 24 is not sufficiently oxidized by the oxygen stored in the three-way catalyst 24. In the present embodiment, the absolute value of the specified amount ΔAfdM is set to a value equal to the specified amount ΔAfd. When it is determined that the value is less than the specified amount ΔAfdM (S50: YES), the CPU 62 determines whether the accumulation count N is greater than or equal to a lower limit value NL that is less than a reference value NH (S52). The lower limit value NL is set to the lower limit value at which the accumulated value InAfd may reflect on the stoichiometric point AfL.

When it is determined that the accumulation count N is greater than or equal to the lower limit value NL (S52: YES), the CPU 62 proceeds to S42. When it is determined that the accumulation count N is less than the lower limit value NL (S52: NO), the CPU 62 proceeds to S48.

When the negative determination is made in the process of S30 or S50 or the process of S48 is completed, the CPU 62 temporarily ends the series of processes shown in FIG. 4.

The operation and advantages of the present embodiment will now be described.

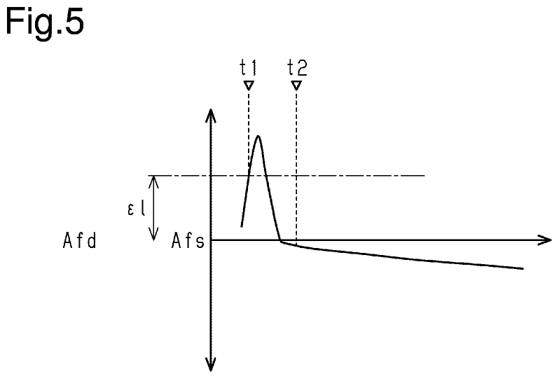

FIG. 5 shows changes in the detection value Afd of the downstream air-fuel ratio sensor 76. At time t1, the CPU 62 sets the target value Afu* to be richer than the stoichiometric air-fuel ratio, which is triggered when the detection value Afd becomes greater than the stoichiometric reference value Afs by the lean side sub-offset amount εl or more (S22). As a result, the air-fuel ratio of the mixture subject to combustion in the combustion chamber 14 is richer than the stoichiometric air-fuel ratio, so that the fluid flowing into the three-way catalyst 24 contains an amount of unburned fuel that is greater than the ideal amount of unburned fuel reacting with all of the oxygen contained in the fluid. Since this large amount of unburned fuel is oxidized by the oxygen stored in the three-way catalyst 24, the amount of oxygen and the amount of unburned fuel in the fluid flowing downstream of the three-way catalyst 24 are negligible. The CPU 62 detects this state when the absolute value of the amount of change in the detection value Afd is decreased in the process of S36 (time t2). The CPU 62 samples the detection value Afd and calculates the stoichiometric point AfL based on the sampled values (S38 to S44).

It is considered that the stoichiometric point AfL is the detection value of the downstream air-fuel ratio sensor 76 when the downstream air-fuel ratio sensor 76 is exposed to the fluid flowing out downstream of the three-way catalyst 24 in a case in which the mixture to be combusted constantly has the stoichiometric air-fuel ratio. For this reason, it is considered that the value obtained by subtracting the stoichiometric reference value Afs from the stoichiometric point AfL is the deviation amount of the detection value of the downstream air-fuel ratio sensor 76 from the stoichiometric reference value Afs. Based on this consideration, the CPU 62 updates the rich side sub-offset amount εr and the lean side sub-offset amount εl. This reduces situations in which the deviation of the detection value of the downstream air-fuel ratio sensor 76 causes the amount of one of oxygen and unburned fuel flowing into the three-way catalyst 24 to be excessive as compared to the ideal amount that reacts with the other one of oxygen and unburned fuel in a single cycle of the process of S16 and the process of S22.

In the present embodiment, when the deviation of the detection value of the downstream air-fuel ratio sensor 76 is negligibly small, the rich side sub-offset amount εr and the lean side sub-offset amount εl are set so that the fluctuation amount of the oxygen storage amount in the three-way catalyst 24 in a single cycle of the process of S16 and the process of S22 is less than or equal to several ten % (for example, 10%) of the maximum value OSmax. When the detection value Afd of the downstream air-fuel ratio sensor 76 deviates, if the air-fuel ratio of the mixture to be combusted deviates from the stoichiometric air-fuel ratio, the detection value Afd is the stoichiometric reference value Afs. Thus, if the rich side sub-offset amount εr and the lean side sub-offset amount εl are not updated based on the stoichiometric point AfL, one of the process of S16 and the process of S22 becomes excessively long and the other becomes excessively short. In a single cycle of the process of S16 and the process of S22, the amount of one of oxygen and unburned fuel flowing into the three-way catalyst 24 becomes excessive as compared to the ideal amount of the one that reacts with the other one of oxygen and unburned fuel. This may cause the oxygen storage amount of the three-way catalyst 24 to gradually change. In this case, for example, if the fuel cut process is not executed during long-term steady driving, the oxygen storage amount of the three-way catalyst 24 may approach zero or the maximum value OSmax. This may lower the exhaust removal performance of the three-way catalyst 24.

### Second Embodiment

The second embodiment will be described below with reference to the drawings focusing on the differences from the first embodiment.

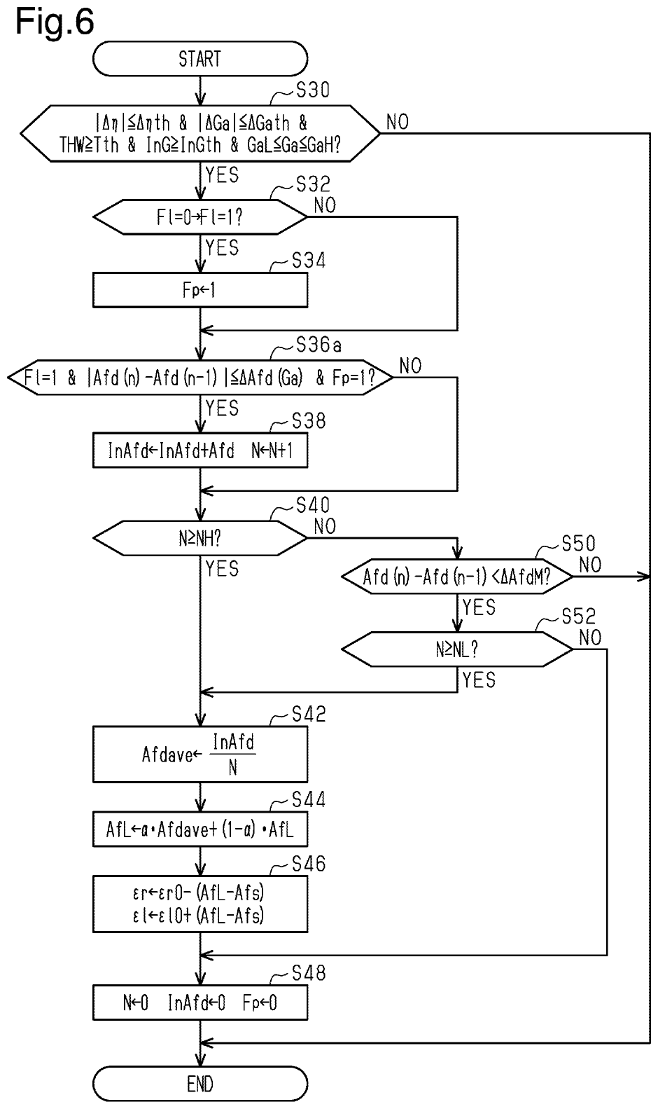

In the first embodiment, the stoichiometric point AfL is updated by sampling the detection value Afd of the downstream side air-fuel ratio a number of times when the process of S22 is executed. However, the decreasing rate of the oxygen storage amount is greater when the flow rate of the fluid flowing into the three-way catalyst 24 is high than when it is low. For this reason, when the flow rate is high, as compared to when it is small, the duration of the process of S22 may shorten or the time taken to satisfy the condition (G) in the process of S36 may excessively shorten. This may result in insufficient sampling of the detection value Afd. In this regard, in the present embodiment, the sampling condition of detection value Afd is changed in accordance with the flow rate of the fluid through the process shown in FIG. 6.

FIG. 6 shows the procedure of the stoichiometric point calculation process M22 according to the present embodiment. The process shown in FIG. 6 is implemented by the CPU 62 repeatedly executing programs stored in the ROM 64, for example, in a predetermined cycle. In FIG. 6, the same step numbers are given to the processes corresponding to the processes shown in FIG. 4. Such processes will not be described in detail.

In the series of processes shown in FIG. 6, when the process of S34 is completed or the negative determination is made in the process of S32, in the process of S36a, which corresponds to the process of S36, the CPU 62 variably sets the specified amount ΔAfd in the condition (G) in accordance with the intake air amount Ga having a positive correlation with the flow rate of the fluid flowing into the three-way catalyst 24. Specifically, taking into consideration that when the intake air amount Ga is large, the decreasing rate of the detection value Afd is greater than when the intake air amount Ga is small, the CPU 62 sets the specified amount ΔAfd to a greater value when the intake air amount Ga is large than when it is small.

Specifically, when the ROM 64 stores in advance map data in which the intake air amount Ga is an input variable and the specified amount ΔAfd is an output variable, the CPU 62 performs map calculation on the specified amount ΔAfd. The map data is set data of discrete values of an input variable and values of an output variable corresponding to each value of the input variable. Also, the map calculation may be performed such that, for example, when the value of an input variable matches any value of the input variable in the map data, the corresponding value of the output variable in the map data may be used as the calculation result. When there is no match, a value obtained by interpolating multiple values of the output variable included in the map data may be used as the calculation result.

According to the processes described above, when the absolute value of the difference between the current detection value Afd and the previous detection value Afd increases due to the large amount of intake air Ga, the specified amount ΔAfd also has a large value. This reduces situations in which when the intake air amount Ga is large, the condition (G) is less likely to be satisfied than when the intake air amount Ga is small.

### Third Embodiment

The third embodiment will be described below with reference to the drawings focusing on the differences from the first embodiment.

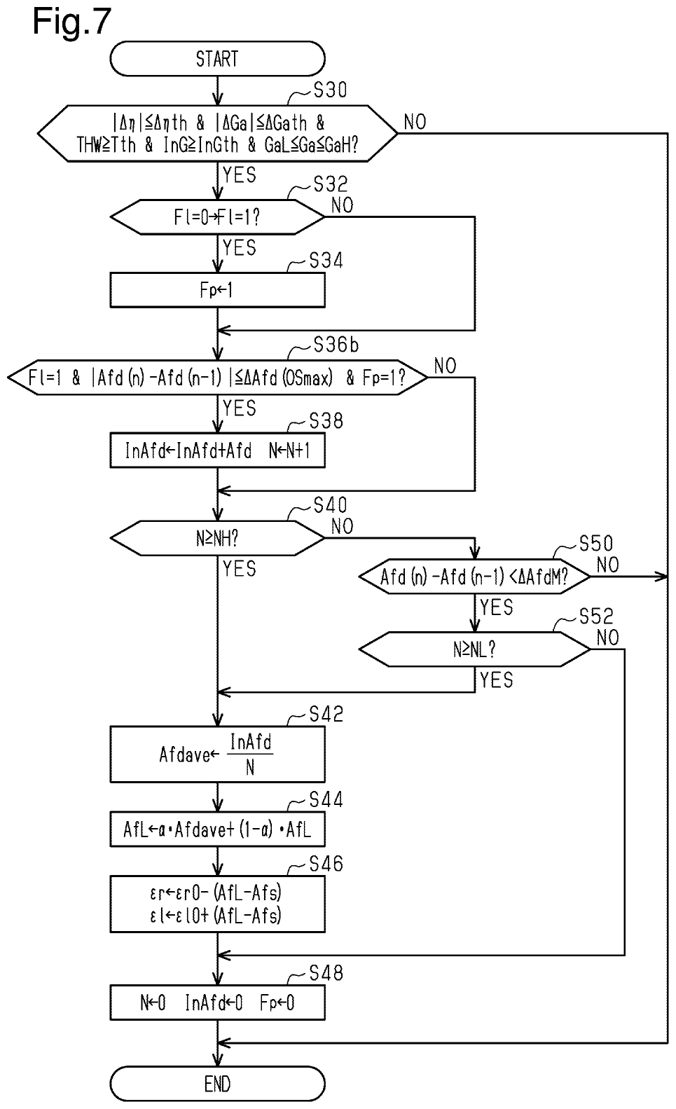

In the first embodiment, the stoichiometric point AfL is updated by sampling the detection value Afd of the downstream side air-fuel ratio a number of times when the process of S22 is executed. However, when deterioration of the three-way catalyst 24 advances, the oxygen storage amount may more quickly become a smaller value. This may shorten the duration of the process of S22 or excessively shorten the time taken to satisfy the condition (G) in the process of S36. As a result, sufficient sampling of the detection value Afd may not be performed. Thus, in the present embodiment, the sampling condition of the detection value Afd is changed in accordance with the level of deterioration of the three-way catalyst 24 through the process shown in FIG. 7.

FIG. 7 shows the procedure of the stoichiometric point calculation process M22 according to the present embodiment. The process shown in FIG. 7 is implemented by the CPU 62 repeatedly executing programs stored in the ROM 64, for example, in a predetermined cycle. In FIG. 7, the same step numbers are given to the processes corresponding to the processes shown in FIG. 4. Such processes will not be described in detail.

In the series of processes shown in FIG. 7, when the process of S34 is completed or the negative determination is made in the process of S32, in the process of S36b, which corresponds to the process of S36, the CPU 62 variably sets the specified amount ΔAfd in the condition (G) in accordance with the maximum value OSmax, which indicates the level of deterioration of the three-way catalyst 24. Specifically, taking into consideration that when the maximum value OSmax is small, the decreasing rate of the detection value Afd is greater than when the maximum value OSmax is large, the CPU 62 sets the specified amount ΔAfd to a greater value when the maximum value OSmax is small than when it is large.

Specifically, when the ROM 64 stores in advance map data in which the maximum value OSmax is an input variable and the specified amount ΔAfd is as an output variable, the CPU 62 performs map calculation on the specified amount ΔAfd.

According to the processes described above, when the absolute value of the difference between the current detection value Afd and the previous detection value Afd increases due to the small maximum value OSmax, the specified amount ΔAfd also has a large value. This reduces situations in which when the maximum value OSmax is small, the condition (G) is less likely to be satisfied than when the maximum value OSmax is large.

### Fourth Embodiment

The fourth embodiment will be described below with reference to the drawings focusing on the differences from the first embodiment.

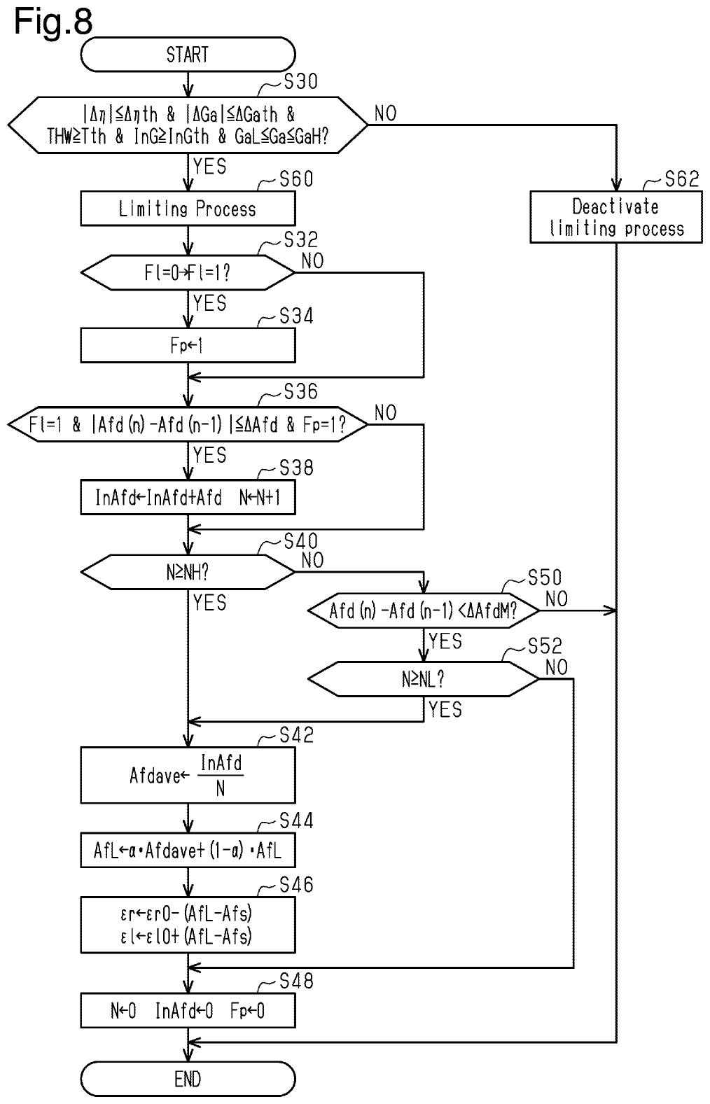

When the output of the internal combustion engine 10 fluctuates, the detection value Afd is likely to fluctuate. If the stoichiometric point AfL is updated using a fluctuating detection value Afd, the accuracy of updating may be lowered. However, for example, if the specified amount ΔAfd of the above condition (G) is decreased, it is difficult to obtain a sufficient number of detection values Afd for updating the stoichiometric point AfL, and the stoichiometric point AfL is updated less frequently. This may lower that the accuracy of the stoichiometric point AfL. In this regard, in the present embodiment, such shortcoming is resolved through the process shown in FIG. 8.

FIG. 8 shows the procedure of the stoichiometric point calculation process M22 according to the present embodiment. The process shown in FIG. 8 is implemented by the CPU 62 repeatedly executing programs stored in the ROM 64, for example, in a predetermined cycle. In FIG. 8, the same step numbers are given to the processes corresponding to the processes shown in FIG. 4. Such processes will not be described in detail.

In the series of processes shown in FIG. 8, when the positive determination is made in the process of S30, the CPU 62 executes a limiting process that limits the amount of change in the output of the internal combustion engine 10 so that its absolute value is decreased (S60). Then, the CPU 62 proceeds to the process of S32. Specifically, the CPU 62 controls most of the amount of change in the output requested for the vehicle by changing the output of the motor generators 32 and 34 and sends a request signal to the ECU 50 to request that changes in the output requested for the internal combustion engine 10 are decreased. When the negative determination is made in the process of S30, the CPU 62 sends a request for deactivating the limiting process to the ECU 50 (S62), and temporarily ends the series of processes shown in FIG. 8.

The operation and advantages of the present embodiment will be described.

When it is determined that the logical conjunction of the conditions (A) to (E) is true, the CPU 62 determines that it is time to execute the update process of the stoichiometric point AfL based on the sampling of the detection value Afd and executes the limiting process. This limits fluctuation of the output of the internal combustion engine 10, thereby limiting fluctuation of the detection value Afd. Thus, the accuracy of the stoichiometric point AfL may be increased.

### Fifth Embodiment

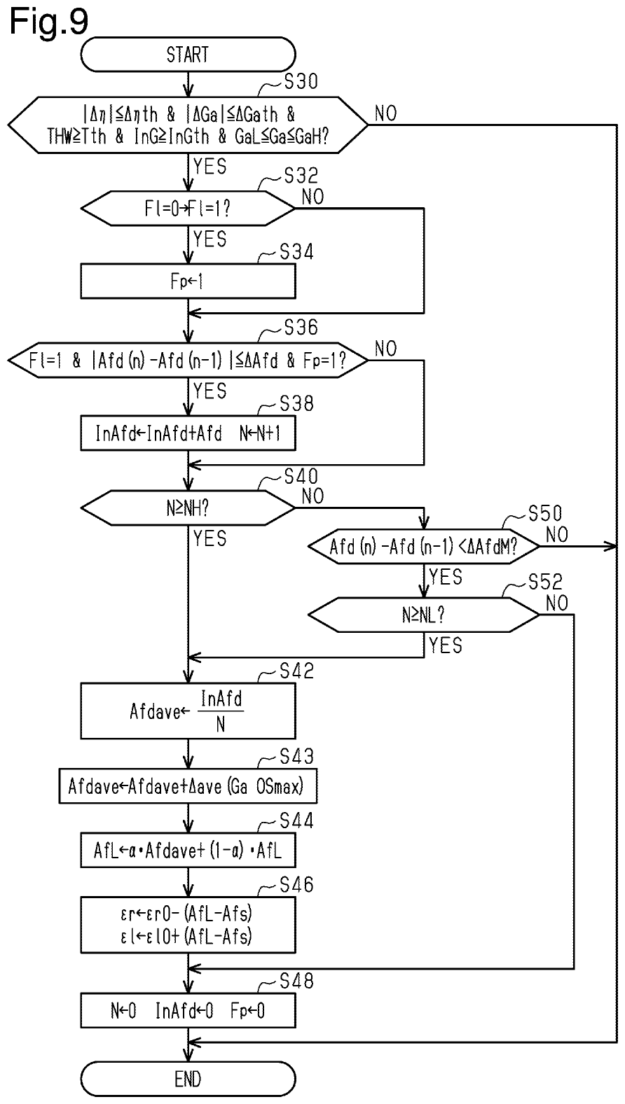

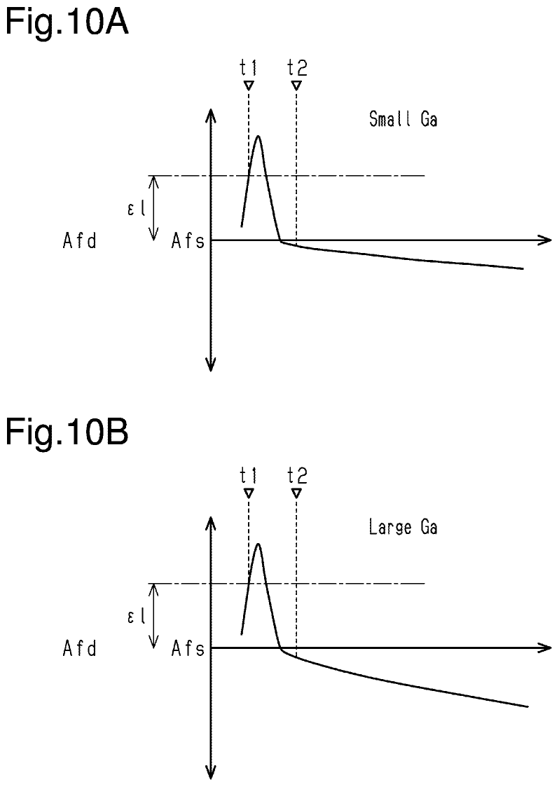

Hereinafter, the fifth embodiment will be described with reference to FIGS. 9, 10A, and 10B focusing on differences from the first embodiment. The fifth embodiment differs from the first embodiment in that the CPU 62 additionally executes the process of S43.

When it is determined that the accumulation count N is greater than or equal to the reference count NH (S40: YES), the CPU 62 assigns a value obtained by dividing the accumulated value InAfd by the accumulation count N to an average value Afdave in order to calculate a simple average process value of the detection value Afd (S42). Next, the CPU 62 calculates a correction amount Δave in accordance with the maximum value OSmax and the intake air amount Ga having a positive correlation with the flow rate of the fluid flowing into the three-way catalyst 24, and corrects the average value Afdave using the correction amount Δave (S43). This process is executed taking into consideration that the average value Afdave is dependent on the maximum value OSmax and the flow rate of the fluid flowing into the three-way catalyst 24 at the time of execution of the process of S22. More specifically, when the ROM 64 stores in advance map data in which the intake air amount Ga and the maximum value OSmax are input variables and the correction amount Δave is an output variable, the CPU 62 performs map calculation on the correction amount Δave. The map data is set data of discrete values of an input variable and values of an output variable corresponding to each value of the input variable. Also, the map calculation may be performed such that, for example, when the value of an input variable matches any value of the input variable in the map data, the corresponding value of the output variable in the map data may be used as the calculation result. When there is no match, a value obtained by interpolating multiple values of the output variable included in the map data may be used as the calculation result.

As shown in FIGS. 10A and 10B, from time t2, when the intake air amount Ga is large (FIG. 10B), the decreasing rate of the detection value Afd after time t2 is greater than when the intake air amount Ga is small (FIG. 10A). This is because in a case in which the process of S22 is executed, when the intake air amount Ga is large, the flow rate of unburned fuel in the fluid flowing into the three-way catalyst 24 is increased as compared to when the intake air amount Ga is small. This increases the decreasing rate of oxygen stored in the three-way catalyst 24. Thus, the average value Afdave may differ depending on the intake air amount Ga. In the same manner, when the maximum value OSmax is decreased due to deterioration of the three-way catalyst 24 or the like, the decreasing rate of the detection value Afd is increased as compared to when the maximum value OSmax is large. In this regard, the CPU 62 corrects the average value Afdave using the correction amount Δave corresponding to the intake air amount Ga and the maximum value OSmax. As a result, regardless of the size of the intake air amount Ga or the maximum value OSmax, the deviation of the average value Afdave is decreased, and hence the deviation of the stoichiometric point AfL is decreased.

### Sixth Embodiment

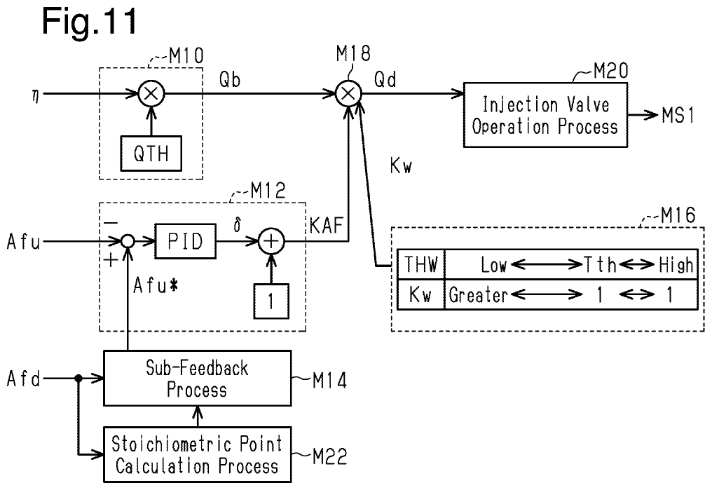

Hereinafter, the sixth embodiment will be described focusing on differences from the first embodiment. As shown in FIG. 11, the sixth embodiment differs from the first embodiment in that the maximum storage amount learning process M24 is omitted. In the sixth embodiment, the stoichiometric point AfL is calculated through the average process averaging multiple detection values Afd. This reduces situations in which noise contained in each detection values Afd affects the stoichiometric point AfL.

### Seventh Embodiment

The seventh embodiment will be described below with reference to the drawings focusing on the differences from the sixth embodiment.

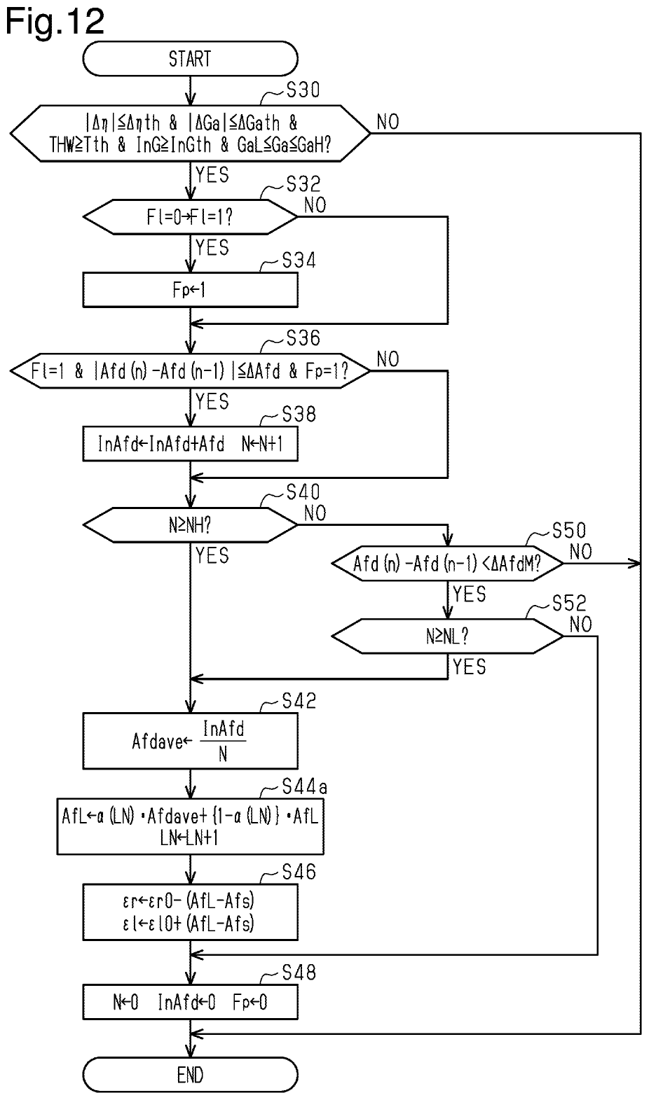

FIG. 12 shows the procedure of the stoichiometric point calculation process M22 according to the present embodiment. The process shown in FIG. 12 is implemented by the CPU 62 repeatedly executing programs stored in the ROM 64, for example, in a predetermined cycle. In FIG. 12, the same step numbers are given to the processes corresponding to the processes shown in FIG. 4. Such processes will not be described in detail.

In the series of processes shown in FIG. 12, when the process of S42 is completed, when calculating the stoichiometric point AfL through the exponential moving average process of the average value Afdave, the CPU 62 variably sets the smoothing coefficient α in accordance with the number of times of execution LN of the exponential moving average process (S44a). More specifically, each time the exponential moving average process is executed in the process of S44a, the CPU 62 increments the number of times of execution LN by one. The CPU 62 sets the smoothing coefficient α to a smaller value when the number of times of execution LN is small than when it is large. This setting further reduces the effect of noise contained in the detection value Afd imposed on the stoichiometric point AfL.

More specifically, the stoichiometric point AfL is expressed as “α·Afdave(n)+α·(1−αa)·Afdave(n−1)+ . . . .” Thus, the number of the average values Afdave that are multiplied by the smoothing coefficient α is the number of times of execution LN. For this reason, when the number of times of execution LN of the exponential moving average process is small, fewer of the average values Afdave reflect on the calculation of the stoichiometric point AfL than when it is large. Thus, the contribution proportion of the past average values Afdave to the stoichiometric point AfL is large. This may increase the effect of noise contained in each detection value Afd used for the calculation of the average value Afdave on the stoichiometric point AfL. In this regard, in the present embodiment, when the number of times of execution LN is small, the smoothing coefficient α is set to a smaller value than when the number of times of execution LN is large. This decreases the contribution proportion of each detection value Afd to the stoichiometric point AfL when the number of times of execution LN is small, thereby reducing the effect of noise contained in each detection value Afd on the stoichiometric point AfL.

When the process of S44a is completed, the CPU 62 proceeds to the process of S46.

### Eighth Embodiment

The eighth embodiment will be described below with reference to the drawings focusing on the differences from the sixth embodiment.

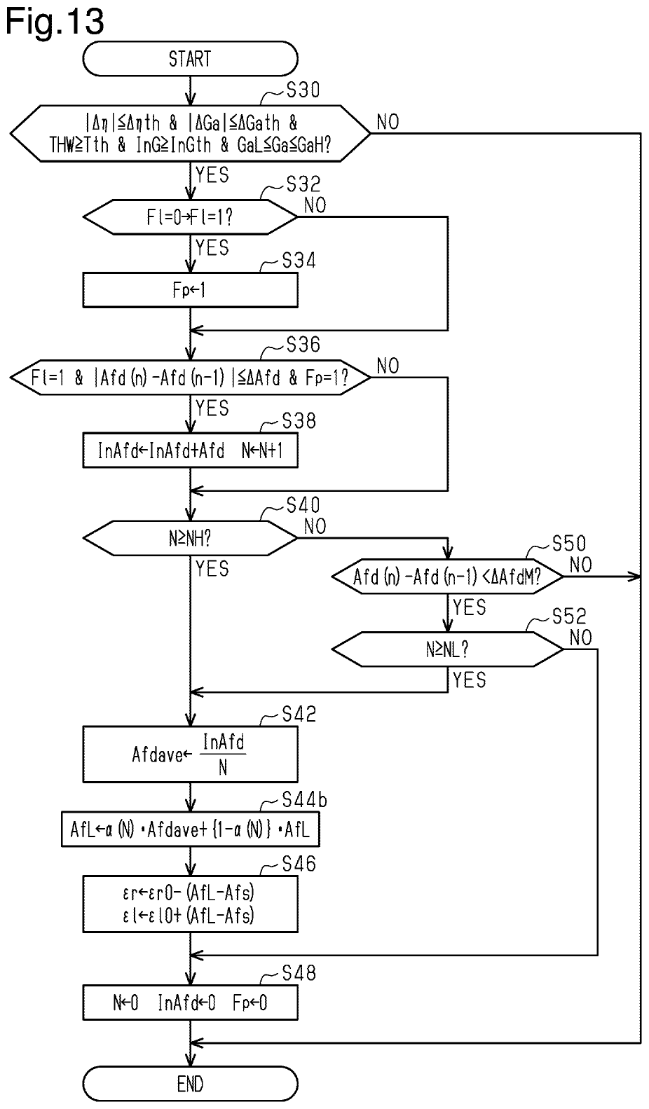

FIG. 13 shows the procedure of the stoichiometric point calculation process M22 according to the present embodiment. The process shown in FIG. 13 is implemented by the CPU 62 repeatedly executing programs stored in the ROM 64, for example, in a predetermined cycle. In FIG. 13, the same step numbers are given to the processes corresponding to the processes shown in FIG. 4. Such processes will not be described in detail.

In the series of processes shown in FIG. 13, when the process of S42 is completed, when calculating the stoichiometric point AfL through the exponential moving average process of the average value Afdave, the CPU 62 variably sets the smoothing coefficient α in accordance with the accumulation count N (S44b). Specifically, when the accumulation count N is small, the CPU 62 sets the smoothing coefficient α to a smaller value than when the accumulation count N is large. This setting further reduces the effect of noise contained in the detection value Afd imposed on the stoichiometric point AfL.

More specifically, the average value Afdave is a sum of values obtained by multiplying the detection values Afd by “1/N” corresponding to the accumulation count N. For this reason, when the accumulation count N is small, the contribution proportion of each detection value Afd to the average value Afdave is large as compared to when the accumulation count N is large. This may increase the effect of noise contained in each detection value Afd imposed on the stoichiometric point AfL. In this regard, in the present embodiment, when the accumulation count N is small, the smoothing coefficient α is set to a smaller value than that when the accumulation count N is large. This decreases the contribution proportion of each detection value Afd to the stoichiometric point AfL when the accumulation count N is small, thereby reducing the effect of noise contained in each detection value Afd on the stoichiometric point AfL.

When the process of S44b is completed, the CPU 62 proceeds to the process of S46.

### Ninth Embodiment

The ninth embodiment will be described below with reference to the drawings focusing on the differences from the sixth embodiment.

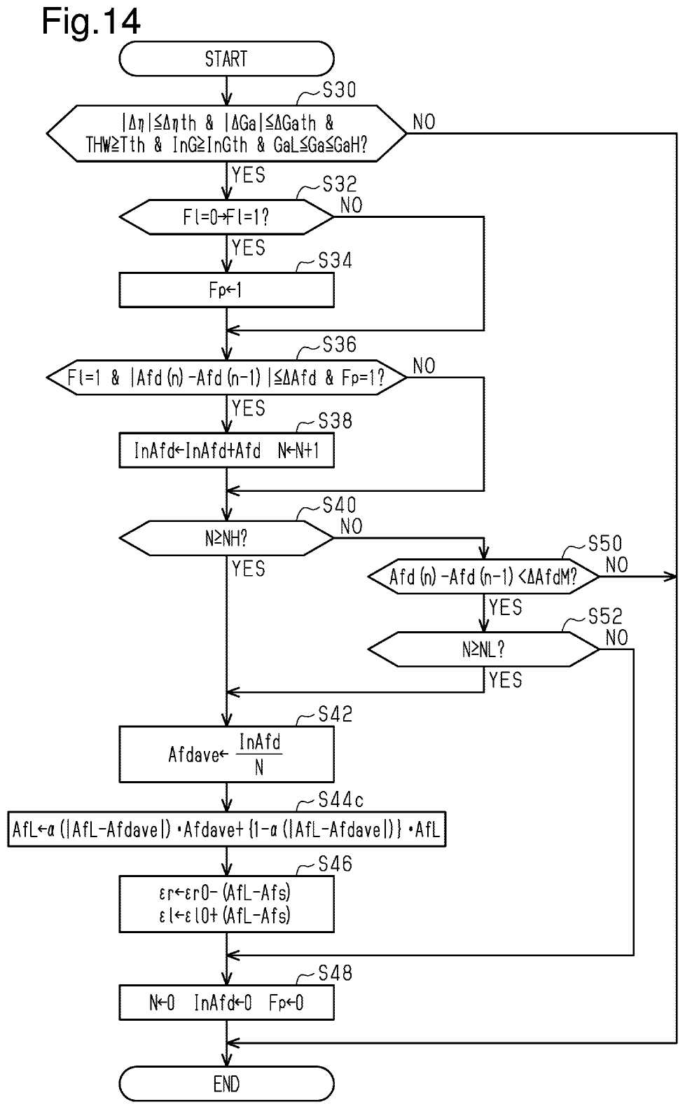

FIG. 14 shows the procedure of the stoichiometric point calculation process M22 according to the present embodiment. The process shown in FIG. 14 is implemented by the CPU 62 repeatedly executing programs stored in the ROM 64, for example, in a predetermined cycle. In FIG. 14, the same step numbers are given to the processes corresponding to the processes shown in FIG. 4. Such processes will not be described in detail.

In the series of processes shown in FIG. 14, when the process of S42 is completed, when calculating the stoichiometric point AfL through the exponential moving average process of the average value Afdave, the CPU 62 variably sets the smoothing coefficient α in accordance with the absolute value of the difference between the stoichiometric point AfL and the average value Afdave (S44c). Specifically, the CPU 62 sets the smoothing coefficient α to a smaller value when the absolute value of the difference between the stoichiometric point AfL and the average value Afdave is large than when it is small. This setting further reduces the effect of noise contained in the detection value Afd imposed on the stoichiometric point AfL.

More specifically, when the absolute value of the difference between the average value Afdave and the stoichiometric point AfL is large, individual detection values Afd do not indicate stable values as compared to when it is small, and the effect of noise is likely to increase. Thus, in the present embodiment, the smoothing coefficient α is set to be a smaller value when the absolute value of the difference between the average value Afdave and the stoichiometric point AfL is large than when it is small, so that the update amount of the stoichiometric point AfL corresponding to each average value Afdave is decreased. This reduces the effect of noise contained in each detection value Afd imposed on the stoichiometric point AfL calculated by the exponential moving average process.

When the process of S44c is completed, the CPU 62 proceeds to the process of S46.

### Tenth Embodiment

The tenth embodiment will be described below with reference to the drawings focusing on the differences from the sixth embodiment.

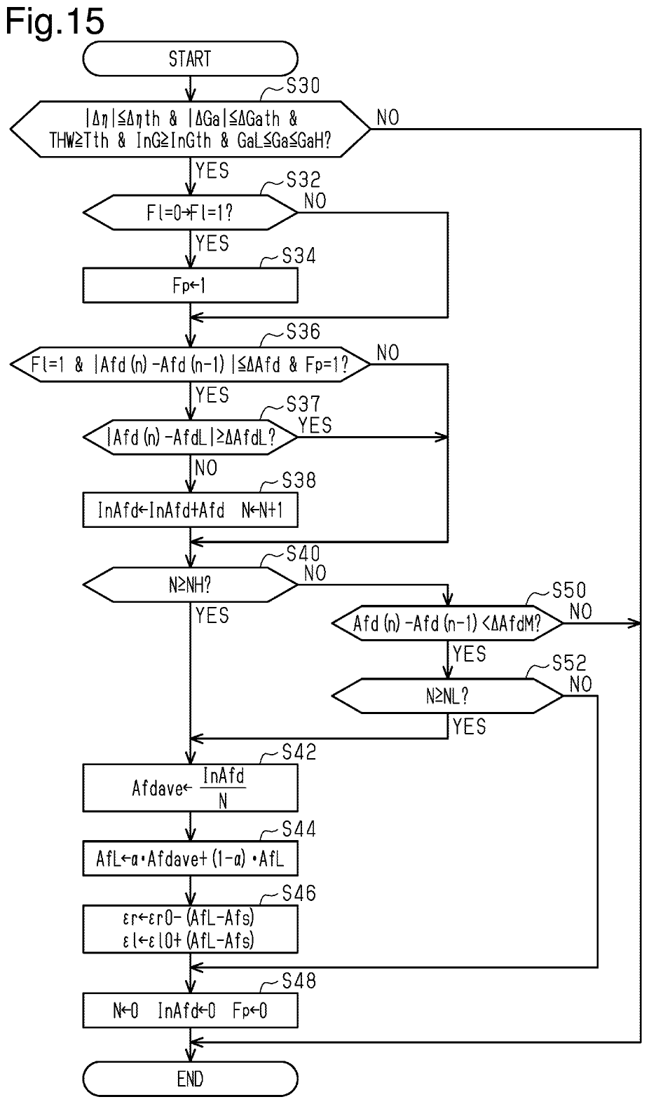

FIG. 15 shows the procedure of the stoichiometric point calculation process M22 according to the present embodiment. The process shown in FIG. 15 is implemented by the CPU 62 repeatedly executing programs stored in the ROM 64, for example, in a predetermined cycle. In FIG. 15, the same step numbers are given to the processes corresponding to the processes shown in FIG. 4. Such processes will not be described in detail.

In the series of processes shown in FIG. 15, when the positive determination is made in the process of S36, the CPU 62 determines whether the absolute value of the difference between the detection value Afd and the stoichiometric point AfL is greater than or equal to the specified amount ΔAfdL (S37). The specified amount ΔAfdL is set to a value less than the specified amount ΔAfd. When it is determined that the absolute value is less than the specified amount ΔAfdL (S37: NO), the CPU 62 proceeds to the process of S38. When it is determined that the absolute value is greater than or equal to the specified amount ΔAdfL (S37: YES), the CPU 62 proceeds to the process of S40. This setting further reduces the effect of noise contained in the detection value Afd imposed on the stoichiometric point AfL.

More specifically, when the absolute value of the difference between the detection value Afd and the stoichiometric point AfL that has been calculated is large, the detection value Afd may be largely affected by incidental noise. In this regard, in the present embodiment, when the absolute value of the difference between the stoichiometric point AfL and the detection value Afd is large, the detection value Afd is not used as an input for the integration process of S38. The contribution proportion to the stoichiometric point AfL is set to zero to reduce the effect of the noise on the stoichiometric point AfL.

### Eleventh Embodiment

The eleventh embodiment will be described below focusing on the differences from the first embodiment. The eleventh embodiment differs from the first embodiment in that the maximum storage amount learning process M24 is omitted. In this respect, the eleventh embodiment has the same configuration as the sixth embodiment shown in FIG. 11. The eleventh embodiment differs from the first embodiment in that the CPU 62 additionally executes the process of S31 and S53.

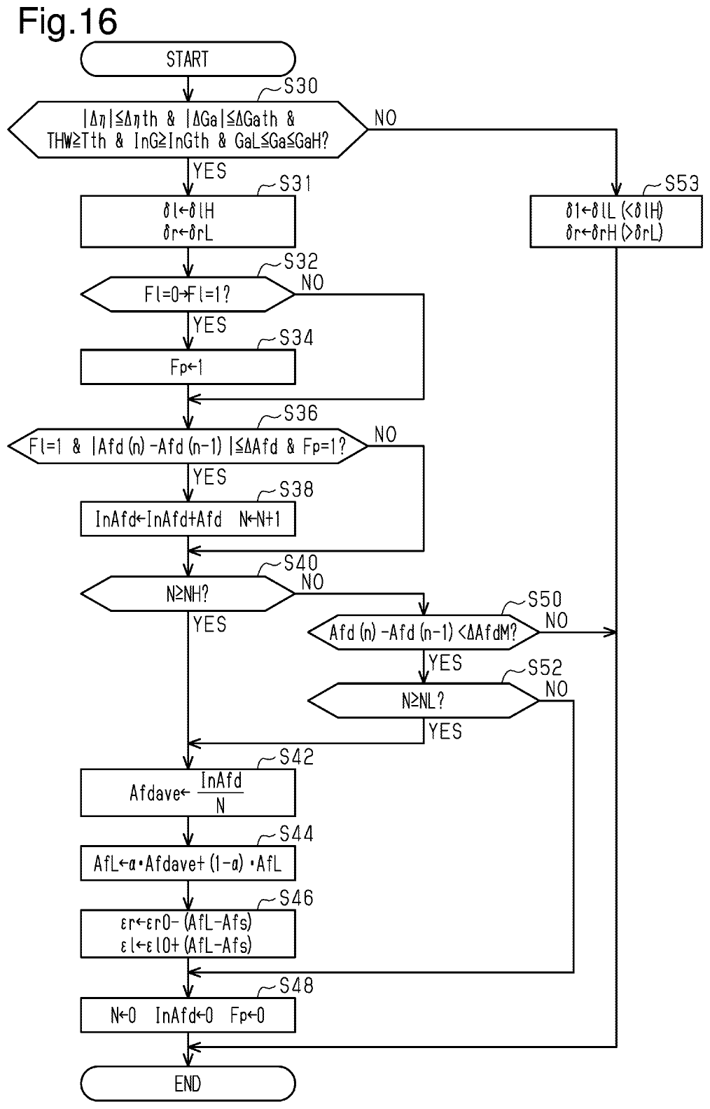

More specifically, as shown in FIG. 16, when it is determined that the logical conjunction of the above conditions (A) to (E) is true (S30: YES), the CPU 62 assigns a lean side detection offset amount δlH to the lean side main offset amount δl, and assigns a rich side detection offset amount δrL to the rich side main offset amount δr (S31).

When the negative determination is made in S30, the CPU 62 assigns a lean side reference offset amount δlL to the lean side main offset amount δl, and assigns a rich side reference offset amount δrH to the rich side main offset amount δr (S53). The lean side reference offset amount δlL is less than the lean side detection offset amount δlH. Further, the rich side reference offset amount δrH is greater than the rich side detection offset amount δrL.

When the process of S48 or S53 is completed or the negative determination is made in step S50, the CPU 62 temporarily ends the series of processes shown in FIG. 16.

The operation and advantages of the eleventh embodiment will be described. The operation and advantages that are the same as those of the first embodiment will not be described.

Furthermore, in the present embodiment, the rich side detection offset amount δrL is less than the rich side reference offset amount δrH. Thus, when the positive determination is made in S30, the amount of unburned fuel in the fluid flowing into the three-way catalyst 24 is decreased during execution of the process of S22 as compared to when the positive determination is not made in S30. This prolongs the duration of the process of S22, which ensures a sufficient sampling period of the detection value Afd.

Furthermore, in the present embodiment, the lean side detection offset amount δlH is greater than the lean side reference offset amount δlL. Thus, when the positive determination is made in S30, the amount of oxygen in the fluid flowing into the three-way catalyst 24 is increased during execution of the process of S16, as compared to when the positive determination is not made in S30. This shortens the duration of S16 process and increases in the proportion of the execution period of the process of S22 in a period in which the internal combustion engine 10 runs. Ultimately, the proportion of a period in which the detection value Afd can be sampled is increased in the period in which the internal combustion engine 10 runs.

### Correspondence

Correspondence between the items in the above embodiments and the items described in the section of “SUMMARY OF THE INVENTION” is as follows. The following description indicates correspondence for each numeral of the aspects described in the section of the “SUMMARY OF THE INVENTION.”

[1] The catalyst corresponds to the three-way catalyst 24. The air-fuel ratio sensor corresponds to the downstream air-fuel ratio sensor 76. The inflow process corresponds to the process of S22. The deviation amount indication value corresponds to the stoichiometric point AfL. The deviation amount calculation process corresponds to the processes of S42 to S46. More specifically, the stoichiometric point AfL is a detection value of the downstream air-fuel ratio sensor 76 as a target when the air-fuel ratio of the mixture to be combusted is the stoichiometric air-fuel ratio. Thus, the difference from the detection value (stoichiometric reference value Afs) of the downstream air-fuel ratio sensor, which is used as a reference, is the deviation amount, and the stoichiometric point AfL is a parameter expressing the deviation amount.

[2] corresponds to the conditions (A) and (B) in S30.

[3] corresponds to the condition (G) in the process of S36.

[4] The predetermined condition corresponds to the condition (G) in S36a, and the condition variable process corresponds to variably setting the specified amount ΔAfd in accordance with the intake air amount Ga in S36a.

[5] The predetermined condition corresponds to the condition (G) in S36b, and the condition variable process corresponds to variably setting the specified amount ΔAfd in accordance with the maximum value OSmax in S36b.

[6] The limiting process corresponds to the process of S60.

[7] The rich determination value corresponds to “Afs−εr,” and the lean control process corresponds to the process of S16. The deviation amount reflection process corresponds to the process of S46. The lean determination value corresponds to “Afs+∂l.”

[8to 10] The catalyst corresponds to the three-way catalyst 24. The air-fuel ratio sensor corresponds to the downstream air-fuel ratio sensor 76. The rich control process corresponds to the process of S22. The deviation amount indication value corresponds to the stoichiometric point AfL. The deviation amount calculation process corresponds to the processes of S38 and S42 to S44. More specifically, the stoichiometric point AfL is a detection value of the downstream air-fuel ratio sensor 76 as a target when the air-fuel ratio of the mixture to be combusted is the stoichiometric air-fuel ratio. Thus, the difference from the detection value (stoichiometric reference value Afs) of the downstream air-fuel ratio sensor, which is used as a reference, is the deviation amount, and the stoichiometric point AfL is a parameter expressing the deviation amount. The phrase “process that calculates the deviation amount indication value to a different value in accordance with the length of the taken time” corresponds to the process of S43. More specifically, the mapping in which the detection value Afd is an input and the stoichiometric point AfL is an output has the correction amount Δave, the value of which differs in accordance with the intake air amount Ga and the maximum value OSmax, and thus differs depending on taken time. When the deviation amount indication value is calculated in accordance with different mappings, the output differs even when the input is the same.

[11] The lean control process corresponds to the process of S16. The simple average process corresponds to the process of S42. The update process corresponds to the process of S44. The correction process corresponds to the process of S43.

[12] The lean control process corresponds to the process of S16. The deviation amount reflection process corresponds to the process of S46.

[13] The catalyst corresponds to the three-way catalyst 24. The air-fuel ratio sensor corresponds to the downstream air-fuel ratio sensor 76. The inflow process corresponds to the process of S22. The deviation amount calculation process corresponds to the processes of S44 to S46, S44a, S44b, and S44c. The deviation amount indication value corresponds to the stoichiometric point AfL. More specifically, the stoichiometric point AfL is a detection value of the downstream air-fuel ratio sensor 76 as a target when the air-fuel ratio of the mixture to be combusted is the stoichiometric air-fuel ratio. Thus, the difference from the detection value (stoichiometric reference value Afs) of the downstream air-fuel ratio sensor, which is used as a reference, is the deviation amount, and the stoichiometric point AfL is a parameter expressing the deviation amount. The moving average process corresponds to the process of S42, S46, S44a, S44b, and S44c.

[14] corresponds to the process of S44a.

[15] corresponds to the process of S44b.

[16] The phrase “absolute value of the difference between the deviation amount indicated by the deviation amount indication value and the deviation amount indicated by the detection value” corresponds to the absolute value of the difference between the stoichiometric point AfL and the detection value Afd. More specifically, the phrase “deviation amount indicated by the deviation amount indication value” corresponds to the difference between the stoichiometric point AfL and the stoichiometric reference value Afs. Thus, the absolute value of the above difference corresponds to the absolute value of “(AfL−Afs)−(Afd−Afs),” which conforms to the absolute value of “AfL−Afd.” The reduction process corresponds to non-execution of the process of S38 when the positive determination is made in the process of S37.

[17] The rich determination value corresponds to “Afs−εr.” The lean control process corresponds to the process of S16. The simple average process corresponds to the process of S42. The update process corresponds to the processes of S46, S44a, S44b, and S44c.

[18] The coefficient variable process corresponds to the process of S44b.

[19] The coefficient variable process corresponds to the process of S44c.

[20] The rich determination value corresponds to “Afs−εr.” The lean control process corresponds to the process of S16. The deviation amount reflection process corresponds to the process of S46.

[21, 22, 24, 25] The catalyst corresponds to the three-way catalyst 24. The air-fuel ratio sensor corresponds to the downstream air-fuel ratio sensor 76. The air-fuel ratio control process corresponds to the base injection amount calculation process M10, the main feedback process M12, the low temperature correction process M16, and the request injection amount calculation process M18. The rich control process corresponds to the process of S22. The lean control process corresponds to the process of S16. The deviation amount indication value corresponds to the stoichiometric point AfL. More specifically, the stoichiometric point AfL is a detection value of the downstream air-fuel ratio sensor 76 as a target when the air-fuel ratio of the mixture to be combusted is the stoichiometric air-fuel ratio. Thus, the difference from the detection value (stoichiometric reference value Afs) of the downstream air-fuel ratio sensor, which is used as a reference, is the deviation amount, and the stoichiometric point AfL is a parameter expressing the deviation amount. The deviation amount calculation process corresponds to the process of S42 to S44. The variable process corresponds to the processes of S31 and S53.

[23] The phrase “multiple detection values” corresponds to detection values, the number of which is greater than or equal to the lower limit value NL.

[26] The deviation amount reflection process corresponds to the process of S46.

### Other Embodiments

The present embodiment can be modified as follows. The present embodiment and the following modifications may be implemented in combination with each other as long as there is no technical contradiction.

### Flow Rate of Fluid Used to Calculate Deviation Amount Indication Value

In the process of S43, the intake air amount Ga is used as the flow rate of the fluid. However, there is no limit to such a configuration. For example, a flow rate of exhaust gas may be used. The flow rate of exhaust gas may be calculated as a sum of the intake air amount Ga and the request injection amount Qd in a predetermined period.

### Correction Process

In the above embodiments, the correction amount Δave of the average value Afdave is calculated based on the intake air amount Ga and the maximum value OSmax. However, there is no limit to such a configuration. For example, the correction amount Δave may be calculated based on only one of the two parameters, namely, the intake air amount Ga and the maximum value OSmax.

### Correction Target Based on Fluid Flow Rate and Maximum Value OSmax

In the above embodiments, the average value Afdave is corrected based on the intake air amount Ga and the maximum value OSmax. However, there is no limit to such a configuration. For example, the detection value Afd that is used to calculate the stoichiometric point AfL may be corrected.

### Inflow Process or Rich Control Process

In the above embodiments, the inflow process or the rich control process is configured by the sub-feedback process M14. However, there is no limit to such a configuration. For example, taking into consideration that the oxygen storage amount of the three-way catalyst 24 is increased when the fuel cut process is executed, the target value Afu* may be set to be richer than the stoichiometric air-fuel ratio immediately after the fuel cut process is executed.

Moreover, there is no limit to a process controlling the air-fuel ratio of the mixture to be combusted to the target value Afu*. The process may configured to, for example, inject fuel from the fuel injection valves 16 in an exhaust stroke to adjust components in the fluid flowing into the three-way catalyst 24.

### Air-Fuel Ratio Control Process

The low temperature correction process M16 does not necessarily have to be executed in the process calculating the request injection amount Qd.

In the above embodiments, the air-fuel ratio is controlled by two-degree-of-freedom control of the open loop control by the base injection amount calculation process M10 and the feedback control by the main feedback process M12. However, the air-fuel ratio control process is not limited to such a configuration. For example, the process may be configured to perform open loop control on a target value Afu* that is determined through the sub-feedback process.

### Variable Process

In the above embodiments, when the logical conjunction of the above conditions (A) to (E) is true, the rich side main offset amount δr is set as the rich side detection offset amount δrL, and the lean side main offset amount δl is set as the lean side detection offset amount MH. However, there is no limit to such a configuration. In an example, while the rich side main offset amount 6r is set as the rich side detection offset amount δrL, the lean side main offset amount δl may be set as the lean side reference offset amount δlL. In another example, while the lean side main offset amount δl is set as the lean side detection offset amount δlH, the rich side main offset amount δr may be set as the rich side reference offset amount δrH.

### Deviation Amount Calculation Process

In the above-described configuration, the stoichiometric point AfL is calculated as the deviation amount indication value, which indicates the deviation amount of the detection value Afd of the air-fuel ratio sensor. However, there is no limit to such a configuration. For example, a deviation amount from the detection value (stoichiometric reference value Afs) of the downstream air-fuel ratio sensor as a reference when the air-fuel ratio of the mixture to be combusted is the stoichiometric air-fuel ratio may be used. This may be implemented by, for example, obtaining an accumulated value of values obtained by subtracting the stoichiometric reference value Afs from the detection values Afd in the process of S38, and obtaining an average value of the values obtained by subtracting the stoichiometric reference value Afs from the detection values Afd in the process of S42.

The stoichiometric point AfL does not necessarily have to be calculated through the simple average process and the exponential moving average process. For example, when the rich side sub-offset amount εr and the lean side sub-offset amount εl are corrected using a value obtained by multiplying the gain K by “AfL−Afs” through the process described below in the section of “Deviation Amount Reflection Process,” the stoichiometric point AfL may be the average value Afdave. Alternatively, for example, the simple average process may be eliminated, and the exponential moving average process value of the detection value Afd may be set as the stoichiometric point AfL. In this case, as described in the section of “Correction Target Based on Fluid Flow Rate or Maximum Value OSmax,” the detection value Afd may be the correction target based on the fluid flow rate or the maximum value OSmax. Further, at least one of the two processes of the simple average process or the exponential moving average process does not necessarily have to be included. For example, the process may be configured to set the stoichiometric point AfL to a value processed through a low-pass filter such as a first-order lag filter to which time-series data of the detection values Afd in a predetermined period is input.

### Coefficient Variable Process

The smoothing coefficient α may be variably set in accordance with three of the absolute value of the difference between the stoichiometric point AfL and the average value Afdave, the number of times of execution LN, and the accumulation count N or may be variably set in accordance with two of the three. This may be implemented, for example, by the CPU 62 performing map calculation on the smoothing coefficient α when the ROM 64 stores in advance map data in which the number of times of execution LN and the accumulation count N are input variables and the smoothing coefficient α is an output variable.

### Reduction Process

In the process of FIG. 9, when the positive determination is made in S37, the detection value Afd(n) is not used in the calculation of the stoichiometric point AfL, and the contribution proportion to the stoichiometric point AfL is zero. However, there is no limit to such a configuration. For example, as described above in the section of “Deviation Amount Calculation Process,” when calculating the stoichiometric point AfL through the exponential moving average process of the detection value Afd without using the simple average process, the smoothing coefficient α may be set to a smaller value when the absolute value of the difference between the detection value Afd (n) and the stoichiometric point AfL is large than when the absolute value is small.

### Execution Condition of Deviation Amount Calculation Process

The execution condition of the deviation amount calculation process does not necessarily have to include a condition that the logical conjunction of the conditions (A) to (E) is true. For example, one of the condition (A) or the condition (B) may be used as the condition indicating that the absolute value of the amount of change in the flow rate of the fluid flowing into the three-way catalyst 24 is less than or equal to the predetermined amount. For example, the condition (C) may be eliminated. Instead of including the condition (D), a sensor such as a thermistor that detects the temperature of the three-way catalyst 24 may be provided, and a condition indicating that the detection value is greater than or equal to a predetermined temperature may be included. For example, as in the process of S36a, when the specified amount ΔAfd is variably set in accordance with the intake air amount Ga in the condition (G), the condition (E) may be eliminated. For example, instead of decreasing the difference between the lower limit value GaL and the upper limit value GaH in the condition (E), the condition (A) and the condition (B) may be eliminated.

For example, instead of using the condition (G), a condition indicating that a predetermined amount of time is elapsed since the lean determination flag Fl was switched to one may be used. For example, instead of using the condition (G), a condition indicating that the absolute value of the difference between the detection value Afd and the stoichiometric reference value Afs is less than or equal to a predetermined value may be used.

As described in the section “Inflow Process or Rich Control Process,” when the inflow process or the rich control process is executed immediately after the fuel cut process, the execution condition may be a state immediately after the fuel cut process.

### Condition Variable Process

In the process of S36a, the specified amount ΔAfd is variably set in accordance with the intake air amount Ga. However, there is no limit to such a configuration. For example, the specified amount ΔAfd may be variably set based on the flow rate of exhaust gas. The flow rate of exhaust gas may be calculated as a sum of the intake air amount Ga and the request injection amount Qd in a predetermined period.

Instead of using the processes of S36a and S36b, the specified amount ΔAfd may be variably set in accordance with the intake air amount Ga and the maximum value OSmax. This may be implemented, for example, by the CPU 62 performing map calculation on the specified amount ΔAfd when the ROM 64 stores in advance map data in which the intake air amount Ga and the maximum value OSmax are input variables and the specified amount ΔAfd is an output variable.

The predetermined condition that is to be mitigated through the condition variable process is not limited to the condition (G). For example, as described in the section of “Execution Condition of Deviation Amount Calculation Process,” instead of using the condition (G), when a condition indicating that the absolute value of the difference between the detection value Afd and the stoichiometric reference value Afs is less than or equal to a predetermined value is used, this condition may be mitigated to increase the predetermined value.

In the condition variable process, multiple detection values Afd do not necessarily have to be used in a single update of the stoichiometric point AfL. For example, as described in the section of “Deviation Amount Calculation Process,” even when the simple average process is eliminated and the exponential moving average process of the detection value Afd is executed, for example, if the intake air amount Ga is large, the condition (G) is not readily satisfied during execution of the process of S22. Thus, the condition variable process is effective.

### Limiting Process

In the above embodiments, when the logical conjunction of the conditions (A) to (E) is true, the limiting process that constantly limits the amount of change in the output to the internal combustion engine 10 so that its absolute value is decreased. However, there is no limit to such a configuration. For example, even when the logical conjunction of the conditions (A) to (E) is true, if the number of times of execution of the process of S44 is greater than or equal to a predetermined value, the limiting process may not be executed. For example, only when the absolute value of the difference between the average value Afdave calculated in S42 and the stoichiometric point AfL is greater than or equal to a predetermined value, the limiting process may be executed.

The above embodiments includes a process, as the limiting process, sending a limitation request to the ECU 50 to request that the absolute value of the amount of change in the required value of the output to the internal combustion engine 10 is decreased. However, there is no limit to such a configuration. In a vehicle including a controller of a single drive system including the ECU 50 and the controller 60, when the logical conjunction of the above conditions (A) to (E) is true, for example, the controller solely executes control that meets the request output by adjusting the output of the motor generators 32 and 34 while setting the output of the internal combustion engine 10 to a fixed value.

### Air-Fuel Ratio Control Process

The low temperature correction process M16 does not necessarily have to be executed in the process calculating the request injection amount Qd.

### Air-Fuel Ratio Control Process

In the above embodiments, the air-fuel ratio is controlled by two-degree-of-freedom control of the open loop control by the base injection amount calculation process M10 and the feedback control by the main feedback process M12. However, the air-fuel ratio control process is not limited to such a configuration. For example, the process may be configured to perform open loop control on a target value Afu* that is determined through the sub-feedback process.

### Deviation Amount Reflection Process

The process that corrects “Afs−εr” as the rich determination value and “Afs+εl” as the lean determination value is not limited to the process exemplified as the process of S46. For example, “AfL−Afs” may be added to the stoichiometric reference value Afs in the processes of S12 and S18 in FIG. 3.

Instead of using the process of S46, a value obtained by multiplying “AfL−Afs” by a gain K that is less than one and greater than zero may be subtracted from the rich side sub-offset amount εr, and the multiplied value may be added to the lean side sub-offset amount εl.

In the above embodiments, the deviation amount reflection process is configured by the process of S46. However, there is no limit to such a configuration. For example, a value obtained by subtracting “AfL−Afs” from the detection value Afd may be used as the detection value Afd that is input to the processes of S12 and S18.

The deviation amount reflection process is not limited to the process that corrects any one of “Afs−εr” as the rich determination value, “Afs+εl” as the lean determination value, and the detection value Afd as a comparison target with the rich determination value and the lean determination value in accordance with the stoichiometric point AfL. For example, when the output of the downstream air-fuel ratio sensor 76 is changed by an electric amount (e.g., applied voltage) supplied to the downstream air-fuel ratio sensor 76, the process may be configured to adjust the electric amount so that the stoichiometric point AfL approaches the stoichiometric reference value Afs.

### Use of Deviation Amount Indication Value

The deviation amount indication value is not limited to a value that reflects on the sub-feedback process M14. For example, when the fuel injection valves 16 are operated so that the air-fuel ratio of the mixture to be combusted is controlled to be the same in the cylinders #1 to #4, the deviation amount indication value may be used in a process that determines the presence or absence of abnormality (imbalance abnormality) in which the mixture to be combusted in one cylinder is richer than the mixture in other cylinders. For example, given that control increases the absolute value of the correction amount of the target value Afu* of the main feedback process M12 when the absolute value of the difference between the detection value Afd of the downstream air-fuel ratio sensor 76 and the stoichiometric reference value Afs is large as compared to when it is small, the determination process may determine the presence or absence of imbalance abnormality based on the correction amount. More specifically, when an imbalance abnormality occurs, the detection value Afu of the upstream air-fuel ratio sensor 74 has a rich side deviation from the air-fuel ratio of the mixtures to be combusted in respective cylinders collected together. Thus, the air-fuel ratio of the mixtures collected together is controlled to be leaner than the stoichiometric air-fuel ratio through the main feedback process M12. As a result, the detection value Afd of the downstream air-fuel ratio sensor 76 becomes leaner than the stoichiometric air-fuel ratio, so that the correction amount includes information on the level of imbalance abnormality. In order to improve the accuracy of the determination process, the detection value Afd used as the input to the calculation process of the correction amount may be corrected based on the stoichiometric point AfL in the same manner as described in the section of “Deviation Amount Reflection Process.” In this case, the corrected detection value Afd is close to the detection value of the reference air-fuel ratio sensor (the value assumed by the controller 60 in the control) whatever value the air-fuel ratio of the mixture to be combusted is. This improves the accuracy of determining presence or absence of an imbalance abnormality based on the correction amount.

### Storage Device of Deviation Amount Indication Value

Although the storage device for storing the stoichiometric point AfL is not particularly described in the above embodiments, the stoichiometric point AfL may be stored, for example, in a RAM used as a volatile memory. In this case, the RAM is initialized as the controller 60 is newly activated, so that the stoichiometric point AfL is not stored in the RAM immediately after the activation. Instead, for example, the stoichiometric point AfL may be constantly stored regardless of activation and deactivation of the controller 60. This may be implemented, for example, by using a non-volatile memory or a backup RAM in which power supply is maintained regardless of the state of the main power supply of the controller 60 as the storage device. Alternatively, for example, a device that includes a RAM as a volatile memory and a non-volatile memory may be used as the storage device for storing the stoichiometric point AfL. In this case, the stoichiometric point AfL stored in the RAM may be sequentially updated by the process of S44, and the stoichiometric point AfL may be stored in the non-volatile memory as a post-process prior to deactivation of the controller 60. In this case, the stoichiometric point AfL stored in the non-volatile memory is stored in the volatile memory as the controller 60 is activated.

### Controller

The controller is not limited to a device that includes the CPU 62 and the ROM 64 and executes software processes. For example, a dedicated hardware circuit (e.g., ASIC) that executes at least some of the software processes executed in the above embodiments may be provided. More specifically, the controller may have any one of the following configurations (a) to (c). Configuration (a) includes a processing device that executes all of the above processes in accordance with programs and a program storage device such as a ROM that stores the programs. Configuration (b) includes a processing device that executes some of the above processes in accordance with programs and a program storage device and a dedicated hardware circuit that executes the remaining processes. Configuration (c) includes a dedicated hardware circuit that executes all of the above processes. Multiple software circuits including the processing device and the program storage device or multiple dedicated hardware circuits may be provided. More specifically, the above processes may be executed by processing circuitry that includes at least one of one or more software circuits or one or more dedicated hardware circuits. The program storage device, or a computer readable medium, includes any available media that can be accessed by a general-purpose computer or a dedicated computer.

### Vehicle

The hybrid vehicle is not limited to a series-parallel hybrid vehicle, but may be, for example, a parallel hybrid vehicle or a series hybrid vehicle. Moreover, the vehicle is not limited to a hybrid vehicle and may be a vehicle solely including the internal combustion engine 10 as the drive source.

### Others

In the above embodiments, the absolute value of the specified amount ΔAfdM in the process of S50 is a value equal to the specified amount ΔAfd in the process of S36. However, there is no limit to such a configuration, and the absolute value may be a value greater than the specified amount ΔAfd. The process of S34 may be executed when the positive determination is made in S32 and the above condition (G) is satisfied. The process of S50 may be shifted to the process of S52 when the condition (G) is not satisfied. In this case, after the process of S38 is started, when the condition (G) is not satisfied, the accumulated value InAfd is initialized.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, wherein the internal combustion engine includes a fuel injection valve, a catalyst provided in an exhaust passage and capable of storing oxygen, and an air-fuel ratio sensor provided downstream of the catalyst in the exhaust passage, the controller comprising processing circuitry, wherein
the processing circuitry is configured to execute an inflow process when an oxygen storage amount of the catalyst is greater than or equal to a predetermined amount,
the inflow process includes operating the fuel injection valve to cause a fluid containing oxygen and unburned fuel to flow into the catalyst,
an amount of the unburned fuel is greater than or equal to an ideal amount of unburned fuel that reacts with all of the oxygen, and
the processing circuitry is configured to execute, based on a detection value of the air-fuel ratio sensor obtained during an execution of the inflow process, a deviation amount calculation process that calculates a deviation amount indication value that indicates a deviation amount of a detection value of the air-fuel ratio sensor.

2. The controller according to claim 1, wherein the deviation amount calculation process includes using, as an input, the detection value obtained when an absolute value of an amount of change in a flow rate of the fluid in a predetermined period is less than or equal to a predetermined amount.

3. The controller according to claim 1, wherein the deviation amount calculation process includes using, as an input, the detection value obtained when an absolute value of an amount of change in the detection value in a predetermined period is less than or equal to a specified amount.

4. The controller according to claim 1, wherein
the deviation amount calculation process includes using, as an input, the detection value obtained when the detection value satisfies a predetermined condition, and
the processing circuitry is configured to execute a condition variable process that mitigates the predetermined condition when a flow rate of the fluid is high as compared to when the flow rate of the fluid is low.

5. The controller according to claim 1, wherein
the deviation amount calculation process includes using, as an input, the detection value obtained when the detection value satisfies a predetermined condition, and
the processing circuitry is configured to execute
a maximum value calculation process that calculates a maximum value of the oxygen storage amount of the catalyst based on the detection value, and
a condition variable process that mitigates the predetermined condition when the maximum value is small as compared to when the maximum value is large.

6. The controller according to claim 1, wherein the processing circuitry is configured to execute a limiting process that limits an amount of change in an output of the internal combustion engine so that when the detection value is acquired as an input of the deviation amount calculation process, an absolute value of the amount of change in the output of the internal combustion engine is decreased as compared to when the detection value is not acquired as an input of the deviation amount calculation process.

7. The controller according to claim 1, wherein
the processing circuitry is configured to execute a lean control process that is triggered when a detection value of the air-fuel ratio sensor is less than or equal to a rich determination value,
the detection value of the air-fuel ratio sensor being equal to the rich determination value indicates that an air-fuel ratio is richer than a stoichiometric air-fuel ratio,
the lean control process includes performing control with operation of the fuel injection valve so that a fluid flowing into the catalyst contains an amount of oxygen that is greater than an ideal amount of oxygen reacting with all of the unburned fuel contained in the fluid,
the processing circuitry is configured to execute a deviation amount reflection process that reflects the deviation amount indication value on the lean control process,
the inflow process includes a rich control process triggered when a detection value of the air-fuel ratio sensor is greater than or equal to a lean determination value,
the detection value of the air-fuel ratio sensor being equal to the lean determination value indicates that an air-fuel ratio is leaner than a stoichiometric air-fuel ratio,
the rich control process includes performing control with operation of the fuel injection valve so that a fluid flowing into the catalyst contains an amount of unburned fuel that is greater than an ideal amount of unburned fuel reacting with all of the oxygen contained in the fluid,
the deviation amount reflection process includes a process that sets a first switching timing at which the rich control process is switched to the lean control process when the deviation amount indication value indicates a lean side deviation amount,
a second switching timing is an assumed timing at which the rich control process is switched to the lean control process when the deviation amount indication value is not reflected on the lean control process, and
the first switching timing is set to be earlier than the second switching timing.

8. The controller according to claim 1, wherein
the processing circuitry is configured to execute a rich control process when the oxygen storage amount of the catalyst is greater than or equal to a predetermined amount,
the rich control process includes operating the fuel injection valve to cause a fluid containing oxygen and unburned fuel to flow into the catalyst, and an amount of the unburned fuel is greater than an ideal amount of unburned fuel that reacts with all of the oxygen,
the processing circuitry is configured to execute a deviation amount calculation process that calculates a deviation amount indication value that indicates a deviation amount of a detection value of the air-fuel ratio sensor based on a detection value of the air-fuel ratio sensor obtained during an execution of the rich control process,
a time taken in the rich control process to decrease the oxygen storage amount of the catalyst from a maximum value to zero is a taken time, and
the deviation amount calculation process includes a process that changes the deviation amount indication value in accordance with a length of the taken time even when the detection value is the same.

9. The controller according to claim 8, wherein
a flow rate of a fluid flowing into the catalyst during an execution of the rich control process is a rich control process flow rate,
the deviation amount calculation process includes a change process that changes the deviation amount indication value based on the taken time being shorter when the rich control process flow rate is high than when the rich control process flow rate is low, and
the change process includes changing the deviation amount indication value in accordance with the rich control process flow rate even when the detection value is the same.

10. The controller according to claim 8, wherein
the processing circuitry is configured to execute a maximum storage amount learning process that learns a maximum value of the oxygen storage amount of the catalyst,
the deviation amount calculation process includes a change process that changes the deviation amount indication value based on the taken time being shorter when the maximum value is small than when the maximum value is large, and
the change process includes changing the deviation amount indication value in accordance with the maximum value even when the detection value is the same.

11. The controller according to claim 8, wherein
the processing circuitry is configured to execute a lean control process that is triggered when a detection value of the air-fuel ratio sensor is less than or equal to a rich determination value during an execution of the rich control process,
the detection value of the air-fuel ratio sensor being equal to the rich determination value indicates that an air-fuel ratio is richer than a stoichiometric air-fuel ratio,
the lean control process includes performing control so that a fluid flowing into the catalyst contains an amount of oxygen that is greater than an ideal amount of oxygen reacting with all of the unburned fuel contained in the fluid,
the rich control process is triggered when a detection value of the air-fuel ratio sensor is greater than or equal to a lean determination value during an execution of the lean control process,
the detection value of the air-fuel ratio sensor being equal to the lean determination value indicates that an air-fuel ratio is leaner than a stoichiometric air-fuel ratio,
the detection value is one of multiple detection values,
the deviation amount calculation process includes
a simple average process that calculates a simple average process value of the multiple detection values in a single period in which the rich control process is executed,
an exponential moving average process using the simple average process value as an input,
an update process that updates the deviation amount indication value through the exponential moving average process in accordance with a cycle in which the rich control process and the lean control process are executed, and
a correction process that corrects the simple average process value in accordance with the length of the taken time, and
the correction process allows the deviation amount indication value to be changed in accordance with the length of the taken time even when the detection values are the same.

12. The controller according to claim 8, wherein
the processing circuitry is configured to execute a lean control process that is triggered when a detection value of the air-fuel ratio sensor is less than or equal to a rich determination value during an execution of the rich control process,
the detection value of the air-fuel ratio sensor being equal to the rich determination value indicates that an air-fuel ratio is richer than a stoichiometric air-fuel ratio,
the lean control process includes performing control so that a fluid flowing into the catalyst contains an amount of oxygen that is greater than an ideal amount of oxygen reacting with all of the unburned fuel contained in the fluid,
the processing circuitry is configured to execute a deviation amount reflection process that reflects the deviation amount indication value on the lean control process,
the rich control process is triggered when a detection value of the air-fuel ratio sensor is greater than or equal to a lean determination value during an execution of the lean control process,
the detection value of the air-fuel ratio sensor being equal to the lean determination value indicates that an air-fuel ratio is leaner than a stoichiometric air-fuel ratio,
the deviation amount reflection process includes a process that sets a first switching timing at which the rich control process is switched to the lean control process when the deviation amount indication value indicates a lean side deviation amount,
a second switching timing is an assumed timing at which the rich control process is switched to the lean control process when the deviation amount indication value is not reflected on the lean control process, and
the first switching timing is set to be earlier than the second switching timing.

13. The controller according to claim 1, wherein
the detection value is one of multiple detection values, and
the deviation amount calculation process includes a process that calculates the deviation amount through an average process that averages the multiple detection values of the air-fuel ratio sensor obtained during an execution of the inflow process.

14. The controller according to claim 13, wherein
the average process includes an exponential moving average process, and
the processing circuitry is configured to execute a coefficient variable process that sets a smoothing coefficient of the exponential moving average process to a smaller value when the exponential moving average process is executed a small number of times than when the exponential moving average process is executed a large number of times.

15. The controller according to claim 13, wherein
the average process includes an exponential moving average process, and
the processing circuitry is configured to execute a coefficient variable process that sets a smoothing coefficient of the exponential moving average process to a smaller value when a small number of samples of the detection values is used for calculating the deviation amount than when a large number of samples of the detection values is used for calculating the deviation amount.

16. The controller according to claim 13, wherein
the average process includes an exponential moving average process, and
when an absolute value of a difference between a deviation amount indicated by the deviation amount indication value and a deviation amount indicated by the detection value is greater than or equal to a predetermined value, the processing circuitry is configured to execute a reduction process that reduces a contribution proportion of the detection value to the exponential moving average process.

17. The controller according to claim 13, wherein
the inflow process includes a rich control process that is triggered when a detection value of the air-fuel ratio sensor is greater than or equal to a lean determination value,
the detection value of the air-fuel ratio sensor being equal to the lean determination value indicates that an air-fuel ratio is leaner than a stoichiometric air-fuel ratio,
the rich control process includes performing control with operation of the fuel injection valve so that a fluid flowing into the catalyst contains an amount of unburned fuel that is greater than an ideal amount of unburned fuel reacting with all of the oxygen contained in the fluid,
the processing circuitry is configured to execute a lean control process that is triggered when a detection value of the air-fuel ratio sensor is less than or equal to a rich determination value,
the detection value of the air-fuel ratio sensor being equal to the rich determination value indicates that an air-fuel ratio is richer than a stoichiometric air-fuel ratio,
the lean control process includes performing control with operation of the fuel injection valve so that a fluid flowing into the catalyst contains an amount of oxygen that is greater than an ideal amount of oxygen reacting with all of the unburned fuel contained in the fluid, and
the deviation amount calculation process includes
a simple average process that calculates a simple average process value of the multiple detection values in a single period in which the rich control process is executed,
an exponential moving average process using the simple average process value as an input, and
an update process that updates the deviation amount indication value through the exponential moving average process in accordance with a cycle in which the rich control process and the lean control process are executed.

18. The controller according to claim 17, wherein the processing circuitry is configured to execute a coefficient variable process that sets a smoothing coefficient of the exponential moving average process to a smaller value when a small number of samples of the detection values is used in the simple average process than when a large number of samples of the detection values is used in the simple average process.

19. The controller according to claim 17, wherein the processing circuitry is configured to execute a coefficient variable process that sets a smoothing coefficient of the exponential moving average process to a smaller value when an absolute value of a difference between the simple average process value used as an input of the exponential moving average process and an exponential moving average process value is large than when the absolute value of the difference is small.

20. The controller according to claim 13, wherein
the inflow process includes a rich control process that is triggered when a detection value of the air-fuel ratio sensor is greater than or equal to a lean determination value,
the detection value of the air-fuel ratio sensor being equal to the lean determination value indicates that an air-fuel ratio is leaner than a stoichiometric air-fuel ratio,
the rich control process includes performing control with operation of the fuel injection valve so that a fluid flowing into the catalyst contains an amount of unburned fuel that is greater than an ideal amount of unburned fuel reacting with all of the oxygen contained in the fluid,
the processing circuitry is configured to execute a lean control process that is triggered when a detection value of the air-fuel ratio sensor is less than or equal to a rich determination value,
the detection value of the air-fuel ratio sensor being equal to the rich determination value indicates that an air-fuel ratio is richer than a stoichiometric air-fuel ratio,
the lean control process includes performing control with operation of the fuel injection valve so that a fluid flowing into the catalyst contains an amount of oxygen that is greater than an ideal amount of oxygen reacting with all of the unburned fuel contained in the fluid,
the processing circuitry is configured to execute a deviation amount reflection process that reflects the deviation amount indication value on the lean control process,
the deviation amount reflection process includes a process that sets a first switching timing at which the rich control process is switched to the lean control process when the deviation amount indication value indicates a lean side deviation amount,
a second switching timing is an assumed timing at which the rich control process is switched to the lean control process when the deviation amount indication value is not reflected on the lean control process, and
the first switching timing is set to be earlier than the second switching timing.

21. A controller for an internal combustion engine, wherein the internal combustion engine includes a fuel injection valve, a catalyst provided in an exhaust passage and capable of storing oxygen, and an air-fuel ratio sensor provided downstream of the catalyst in the exhaust passage, the controller comprising: processing circuitry, wherein
the processing circuitry is configured to execute an air-fuel ratio control process that operates the fuel injection valve to control an air-fuel ratio of a mixture in a combustion chamber of the internal combustion engine to a target value,
the processing circuitry is configured to execute a rich control process that is triggered when a detection value of the air-fuel ratio sensor is greater than or equal to a lean determination value,
the detection value of the air-fuel ratio sensor being equal to the lean determination value indicates that an air-fuel ratio is leaner than a stoichiometric air-fuel ratio,
the rich control process includes setting the target value to be richer than the stoichiometric air-fuel ratio,
the processing circuitry is configured to execute a lean control process that is triggered when the detection value of the air-fuel ratio sensor is less than or equal to a rich determination value,
the detection value of the air-fuel ratio sensor being equal to the rich determination value indicates that the air-fuel ratio is richer than the stoichiometric air-fuel ratio,
the lean control process includes setting the target value to be leaner than the stoichiometric air-fuel ratio,
the processing circuitry is configured to execute a deviation amount calculation process when an execution condition of a process that calculates a deviation amount indication value indicating a deviation amount of a detection value of the air-fuel ratio sensor is satisfied,
the deviation amount calculation process includes calculating the deviation amount indication value based on a detection value of the air-fuel ratio sensor obtained during an execution of the rich control process,
the processing circuitry is configured to execute a variable process that variably sets at least one of the target value set by the rich control process or the target value set by the lean control process, and
the target value variably set when the execution condition is satisfied differs from the target value variably set when the execution condition is not satisfied.

22. The controller according to claim 21, wherein the variable process includes a process that sets the target value set by the rich control process to be closer to the stoichiometric air-fuel ratio when the deviation amount calculation process is executed than when the deviation amount calculation process is not executed.

23. The controller according to claim 22, wherein
the detection value is one of multiple detection values detected while the rich control process is continued, and
the deviation amount calculation process includes a process that uses the multiple detection values in a single updating process of the deviation amount indication value.

24. The controller according to claim 21, wherein the variable process includes a process that sets the target value set by the lean control process to be leaner when the execution condition is satisfied than when the execution condition is not satisfied.

25. The controller according to claim 21, wherein
the air-fuel ratio sensor is a downstream air-fuel ratio sensor,
the internal combustion engine includes an upstream air-fuel ratio sensor provided upstream of the catalyst, and
the air-fuel ratio control process includes a process that feedback-controls a detection value of the upstream air-fuel ratio sensor to the target value.

26. The controller according to claim 21, wherein
the processing circuitry is configured to execute a deviation amount reflection process that reflects the deviation amount indication value on the lean control process,
the deviation amount reflection process includes a process that sets a first switching timing at which the rich control process is switched to the lean control process when the deviation amount indication value indicates a lean side deviation amount,
a second switching timing is an assumed timing at which the rich control process is switched to the lean control process when the deviation amount indication value is not reflected on the lean control process, and
the first switching timing is set to be earlier than the second switching timing.
